(19) United States
(12) Patent Application Publication
(10) Pub. No.: US 2019/0229964 A1
(43) Pub. Date: Jul. 25, 2019

(54) TERMINAL APPARATUS AND METHOD

(71) Applicants: SHARP KABUSHIKI KAISHA, Sakai City, Osaka (JP); FG Innovation Compnay Limited, Tuen Mun (CN)

(72) Inventors: WATARU OUCHI, Sakai City (JP); SHOICHI SUZUKI, Sakai City (JP); TOMOKI YOSHIMURA, Sakai City (JP); LIQING LIU, Sakai City (JP)

(73) Assignee: SHARP KABUSHIKI KAISHA, Sakai City, Osaka (JP)

(21) Appl. No.: 16/317,315

(22) PCT Filed: Jul. 7, 2017
(86) PCT No.: PCT/JP2017/024957

§ 371 Date: Jan. 11, 2019

(30) Foreign Application Priority Data
Jul. 15, 2016 (JP) 2016-140064

(51) Int. Cl. H04L 27/26; H04W 72/04

(52) U.S. Cl. CPC H04L 27/2613; H04W 92/18; H04W 72/0406

(57) ABSTRACT

A terminal apparatus includes: a sequence generation unit configured to generate a first sequence for a first reference signal, based on a first parameter, and generate a second sequence for a second reference signal; and a mapping unit configured to map each of the sequences to a physical resource, wherein the sequence generation unit configures the first parameter to a first value in a case that a terminal apparatus speed does not exceed a first threshold, and configures the first parameter to a second value in a case that the terminal apparatus speed exceeds the first threshold, and the mapping unit maps the second sequence to a physical resource, based on the sequence for the first reference signal.

### TECHNICAL FIELD

Embodiments of the present invention relate to a technique of a terminal apparatus and a method that enables efficient communication.

This application claims priority based on Japanese Patent Application No. 2016-140064 filed on Jul. 15, 2016, the contents of which are incorporated herein by reference.

### BACKGROUND ART

The 3rd General Partnership Project (3GPP), which is a standardization project, has standardized the Evolved Universal Terrestrial Radio Access (EUTRA), in which high-speed communication is achieved by adopting an Orthogonal Frequency Division Multiplexing (OFDM) communication scheme and flexible scheduling on a given frequency and time basis called a resource block. A general communication adopting the technology standardized in the EUTRA is also referred to as the Long Term Evolution (LTE) communication, in some cases.

Moreover, the 3GPP discusses Advanced EUTRA (A-EUTRA), which realizes higher-speed data transmission and has upper compatibility with the EUTRA. The EUTRA relates to a communication system based on a network in which base station apparatuses have substantially the same cell configuration (cell size); however, regarding the A-EUTRA, discussion is made on a communication system based on a network (different-type radio network, heterogeneous network) in which base station apparatuses (cells) having different configurations coexist in the same area.

Furthermore, the 3GPP discusses a technique for realizing a Vehicle to Everything (V2X) service (NPL 1).

### CITATION LIST

### Non Patent Literature

NPL 1: “3GPP TR 36.885 v.1.0.0 (2016-03)”, RP-160439, 7th-10th Mar. 2015.

### SUMMARY OF INVENTION

### Technical Problem

A communication device (terminal apparatus and/or base station apparatus) may not perform efficient communication by transmission control of related art in some cases.

An aspect of the present invention has been made in consideration of the above, and an object of the aspect of the present invention is to provide a terminal apparatus and a method capable of the transmission control for enabling efficient control.

### Solution to Problem

(1) In order to accomplish the object described above, an aspect of the present invention is contrived to provide the following means. Specifically, a terminal apparatus according to an aspect of the present invention includes: a sequence generation unit configured to generate a first sequence for a first reference signal, based on a first parameter, and generate a second sequence for a second reference signal; and a mapping unit configured to map each of the sequences to a physical resource, wherein the sequence generation unit configures the first parameter to a first value in a case that a terminal apparatus speed does not exceed a first threshold, and configures the first parameter to a second value in a case that the terminal apparatus speed exceeds the first threshold, and the mapping unit maps the second sequence to a physical resource, based on the sequence for the first reference signal.

(2) A method according to an aspect of the present invention includes the steps of: generating a first sequence for a first reference signal, based on a first parameter; generating a second sequence for a second reference signal; mapping each of the sequences to a physical resource; configuring the first parameter to a first value in a case that a terminal apparatus speed does not exceed a first threshold; configuring the first parameter to a second value in a case that the terminal apparatus speed exceeds the first threshold; and mapping the second sequence to a physical resource based on the sequence for the first reference signal.

### Advantageous Effects of Invention

An aspect of the present invention can provide improved transmission efficiency in a radio communication system in which a base station apparatus and a terminal apparatus communicate with each other.

### BRIEF DESCRIPTION OF DRAWINGS

FIG. 1 is a diagram illustrating an example of a downlink radio frame configuration according to a first embodiment.

FIG. 2 is a diagram illustrating an example of an uplink and/or sidelink radio frame configuration according to the first embodiment.

FIGS. 3A to 3C are diagrams illustrating examples of a mapping pattern of a sidelink physical channel and a DMRS associated with the sidelink physical channel according to the first embodiment.

FIG. 4 is a diagram illustrating an example of a block configuration of a base station apparatus according to the first embodiment.

FIG. 5 is a diagram illustrating an example of a block configuration of a terminal apparatus according to the first embodiment.

### DESCRIPTION OF EMBODIMENTS

### First Embodiment

A first embodiment of the present invention will be described below. A description will be given by using a communication system in which a base station apparatus (base station, NodeB, or eNB (EUTRAN NodeB, evolved NodeB)) and a terminal apparatus (terminal, mobile station, a user device, or User equipment (UE)) communicate in a cell.

Major physical channels, physical signals, and a frame structure used in the present embodiment will be described. The “channel” refers to a medium used to transmit a signal, and the “physical channel” refers to a physical medium used to transmit a signal. In the present embodiment, the physical channel may be used synonymously with “physical signal.” In the future LTE, the physical channel may be added or its structure/configuration and format may be changed or added; however, the description of the embodiments of the present invention will not be affected even if the channel is changed or added.

A description is given of frame structure types according to the present embodiment.

Frame structure type 1 (FS1) is applied to Frequency Division Duplex (FDD). Specifically, the FS1 is applied to a cell operation supporting the FDD. The FS1 can be applied to both Full Duplex-FDD (FD-FDD) and Half Duplex-FDD (HD-FDD).

In the FDD, downlink transmission and uplink transmission are divided in a frequency domain. In other words, an operating band is defined for each of the downlink transmission and the uplink transmission. Specifically, carrier frequencies different between the downlink transmission and the uplink transmission are adopted. Therefore, in the FDD, 10 subframes can be used for each of the downlink transmission and the uplink transmission. The terminal apparatus cannot simultaneously perform transmission and reception in the HD-FDD operation, but the terminal apparatus can simultaneously perform transmission and reception in the FD-FDD operation.

The terminal apparatus cannot simultaneously perform transmission and reception in the HD-FDD operation, but the terminal apparatus can simultaneously perform transmission and reception in the FD-FDD operation.

The HD-FDD includes two types. For a type A-HD-FDD operation, a guard period is generated by a terminal apparatus not receiving a tail end part (tail end symbol) of a downlink subframe immediately before an uplink subframe from the same terminal apparatus. For a type B-HD-FDD operation, a guard period referred to as a HD guard subframe is generated by a terminal apparatus not receiving a downlink subframe immediately before an uplink subframe from the same terminal apparatus, and not receiving a downlink subframe immediately after an uplink subframe from the same terminal apparatus. Specifically, in the HD-FDD operation, the terminal apparatus controls a reception process on the downlink subframe to generate a guard period. The symbol may include any of OFDM symbol and a SC-FDMA symbol.

Frame structure type 2 (FS2) is applied to Time Division Duplex (TDD). Specifically, the FS2 is applied to a cell operation supporting the TDD. Each radio frame includes two half frames. Each half frame includes five subframes. A UL-DL configuration in a certain cell may be changed between the radio frames. Control of a subframe in the uplink or downlink transmission may be performed in the last radio frame. The terminal apparatus can acquire the UL-DL configuration in the last radio frame through a PDCCH or higher layer signaling. The UL-DL configuration indicates configurations of the uplink subframe, downlink subframe, and special subframe in the TDD. The special subframe includes a Downlink Pilot Time Slot (DwPTS) capable of downlink transmission, a guard period (GP), and an Uplink Pilot Time Slot (UpPTS) capable of uplink transmission. Configurations of the DwPTS and UpPTS in the special subframe are managed in a table, and the terminal apparatus can acquire the configurations through higher layer signaling. The special subframe is a switching point from the downlink to the uplink. Specifically, the terminal apparatus makes a transition from the reception to the transmission and the base station apparatus makes a transition from the transmission to the reception across the switching point as a boundary. The switching point has a 5 ms periodicity and a 10 ms periodicity. In a case of the switching point of the 5 ms periodicity, the special subframe exists in both the half frames. In a case of the switching point of the 10 ms periodicity, the special subframe exists only in a first half frame.

In a case that two symbols are allocated to the UpPTS, a Sounding Reference Signal (SRS) and Physical Random Access Channel (PRACH) preamble format 4 can be mapped.

In the TDD, TDD enhanced Interference Management and Traffic Adaptation (eIMTA) technology can be adopted which takes a communication amount (traffic amount) or interference of each cell into account. The eITMA is a technology in which the configuration of the TDD is switched dynamically (using a Layer 1 (L1) level or L1 signaling) taking the communication amount or an interference amount of the downlink and/or uplink into account such that a ratio of the downlink subframes and the uplink subframes occupied in the radio frame (i.e., in 10 subframes) is changed, for performing an optimal communication.

To the FS1 and the FS2, a Normal Cyclic Prefix (NCP) and an Extended Cyclic Prefix (ECP) are applied.

Frame structure type 3 (FS3) is applied to a Licensed Assisted Access (LAA) secondary cell operation. To the FS3, only the NCP may be applied. 10 subframes contained in the radio frame are used for the downlink transmission. The terminal apparatus does not presume that any signal exists in a certain subframe unless otherwise defined or unless otherwise the downlink transmission is detected in the subframe, and processes the subframe as a blank subframe. The downlink transmission occupies one or multiple contiguous subframes. The contiguous subframes include the first subframe and an end subframe. The first subframe starts from any symbol or slot (e.g., an OFDM symbol #0 or #7) of the first subframe. In the end subframe, a full subframe (that is, 14 OFDM symbols) or the number of OFDM symbols indicated based on one of DwPTS durations are occupied. Whether or not a certain subframe among the contiguous subframes is the end subframe is indicated to the terminal apparatus by a certain field included in a DCI format. That field may further indicate the number of OFDM symbols used for a subframe where that field is detected or a subframe next to the subframe. In the FS3, the base station apparatus performs a channel access procedure associated with LBT before the downlink transmission.

In the FS3, only the downlink transmission is supported, but the uplink transmission may be supported. In this case, the FS3 supporting only the downlink transmission may be defined as a FS3-1 or a FS3-A, and the FS3 supporting the downlink transmission and the uplink transmission may be defined as a FS3-2 or a FS3-B.

The terminal apparatus and the base station apparatus supporting the FS3 may communicate in an unlicensed frequency band.

An operating band corresponding to LAA or FS3 cell maybe managed with a table for an EUTRA operating band. For example, an index of the EUTRA operating band is managed by 1 to 44, and an index of an operating band corresponding to the LAA (or the LAA frequency) may be managed by 46. For example, the index 46 may define the downlink frequency band only. Some indexes may be reserved for the uplink frequency band or ensured in advance assuming that the uplink frequency band is defined in the future. A corresponding duplex mode may be a duplex mode different from the FDD and TDD, or may be the FDD or the TDD. A frequency capable of the LAA operation is preferably 5 GHz or more, by may be 5 GHz or less. Specifically, communication in the LAA operation may be performed at a frequency associated as an operating band corresponding to the LAA.

Next, a description is given of downlink and uplink radio frame configurations according to the present embodiment.

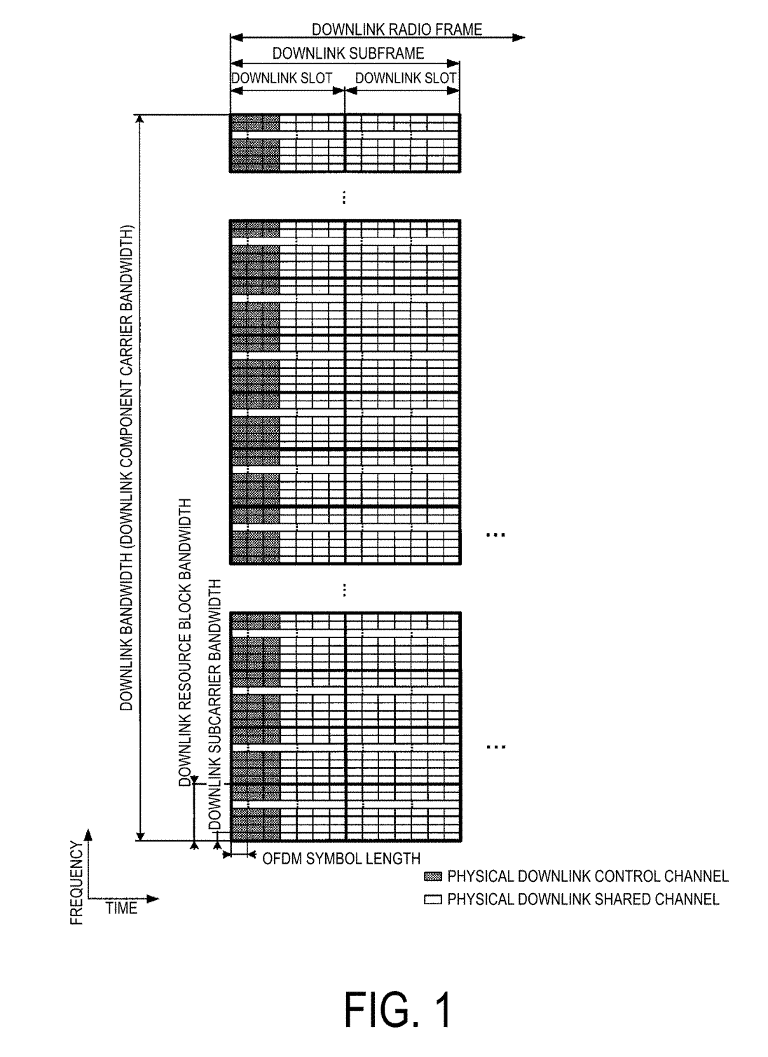

FIG. 1 is a diagram illustrating an example of a downlink radio frame configuration according to the present embodiment. In the downlink, an OFDM access scheme is used.

The following downlink physical channels may be used for downlink radio communication from the base station apparatus to the terminal apparatus. Here, the downlink physical channels are used to transmit the information output from higher layers.

Physical Broadcast Channel (PBCH)

Physical Control Format Indicator Channel (PCFICH)

Physical Hybrid automatic repeat request Indicator Channel (PHICH)

Physical Downlink Control Channel (PDCCH)

Enhanced Physical Downlink Control Channel (EPDCCH)

sPDCCH (short/shorter/shortened Physical Downlink Control Channel, PDCCH for sTTI)

PDSCH (Physical Downlink Shared Channel)

sPDSCH (short/shorter/shortened Physical Downlink Shared Channel, PDCCH for sTTI)

Physical Multicast Channel (PMCH)

The following downlink physical signals may be used in the downlink radio communication. Here, the downlink physical signals are not used to transmit the information output from the higher layers but is used by the physical layer.

Synchronization signal (SS)

Downlink Reference Signal (DL RS)

Discovery Signal (DS)

According to the present embodiment, the following five types of downlink reference signals may be used.

Cell-specific Reference signal (CRS)

UE-specific Reference Signal (URS) associated with the PDSCH

Demodulation Reference Signal (DMRS) associated with the EPDCCH

Non-Zero Power Channel State Information-Reference Signal (NZP CSI-RS)

Zero Power Channel State Information-Reference Signal (ZP CSI-RS)

Multimedia Broadcast and Multicast Service over Single Frequency Network Reference signal (MBSFN RS)

Positioning Reference Signal (PRS)

A downlink radio frame is constituted by a downlink resource block (RB) pair. This downlink RB pair is a unit for allocation of a downlink radio resource and the like and is constituted by a frequency band of a predefined width (RB bandwidth) and a predefined time duration (two slots=1 subframe). Each of the downlink RB pairs is constituted of two downlink RBs (RB bandwidth×slot) that are contiguous in the time domain. Each of the downlink RBs is constituted of 12 subcarriers in frequency domain. In the time domain, the downlink RB is constituted of seven OFDM symbols in a case that an NCP is added, while the downlink RB is constituted of six OFDM symbols in a case that an ECP that is longer than an NCP is added. A region defined by a single subcarrier in the frequency domain and a single OFDM symbol in the time domain is referred to as a resource element (RE). The PDCCH/EPDCCH is a physical channel on which downlink control information (DCI) such as a terminal apparatus identifier, PDSCH scheduling information, Physical Uplink Shared Channel (PUSCH) scheduling information, a modulation scheme, a coding rate, and a retransmission parameter are transmitted. Note that although a downlink subframe in a single component carrier (CC) is described here, a downlink subframe is defined for each CC and downlink subframes are approximately synchronized between the CCs. Here, being approximately synchronized between the CCs means that in a case of transmission from the base station apparatus by using multiple CCs, an error between transmission timings of the CCs falls within a prescribed range.

Although not illustrated, the SS, PBCH, and DLRS may be mapped to the downlink subframes. Examples of the DLRS include a CRS transmitted using an antenna port (transmission port) the same as that for the PDCCH, a CSI-RS used to measure the channel state information (CSI), a URS transmitted using an antenna port the same as that for some PDSCHs, and a DMRS transmitted using a transmission port the same as that for the EPDCCH. Moreover, carriers on which no CRS is mapped may be used. In this case, a similar signal (referred to as an enhanced synchronization signal) to a signal corresponding to one or some antenna ports (e.g., only antenna port 0) or all the antenna ports for the CRSs can be inserted into one or some subframes (e.g., the first and sixth subframes in the radio frame) as time and/or frequency tracking signals. Here, the antenna port may be referred to as the transmission port. Here, the “physical channel/physical signal is transmitted using the antenna port” also means that the physical channel/physical signal is transmitted using a radio resource or layer corresponding to the antenna port. For example, this means that a receiver receives the physical channel or physical signal from a radio resource or layer corresponding to the antenna port.

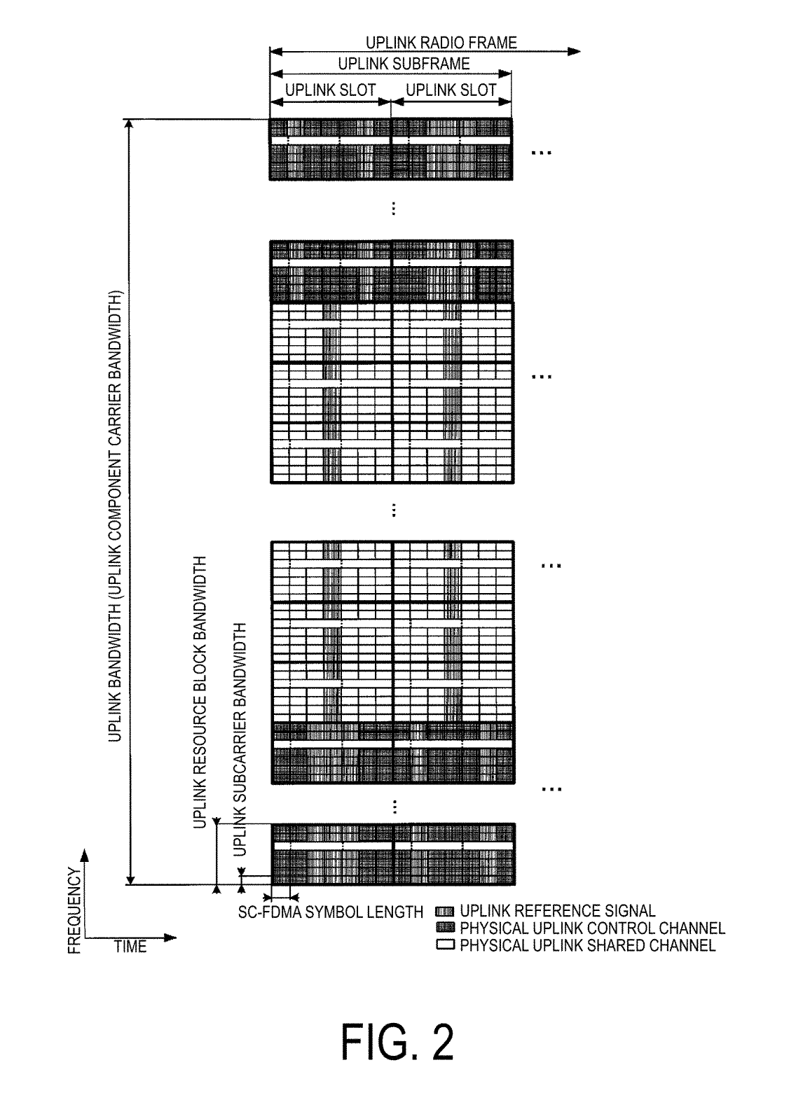

FIG. 2 is a diagram illustrating an example of an uplink radio frame configuration according to the present embodiment. An SC-FDMA scheme is used in the uplink.

In uplink radio communication from the terminal apparatus to the base station apparatus, the following uplink physical channels may be used. Here, the uplink physical channels are used to transmit information output from the higher layers.

Physical Uplink Control Channel (PUCCH)

sPUCCH (short/shorter/shortened Physical Uplink Control Channel, PUCCH for short TTI)

PUSCH (Physical Uplink Shared Channel)

sPUSCH (short/shorter/shortened Physical Uplink Shared Channel, PUSCH for short TTI)

PRACH (Physical Random Access Channel)

sPRACH (short/shorter/shortened Physical Random Access Channel, PRACH for short TTI)

The following uplink physical signal may be used for uplink radio communication. Here, the uplink physical signal is not used to transmit information output from the higher layers but is used by the physical layer.

Uplink Reference Signal (UL RS)

According to the present embodiment, the following two types of uplink reference signals may be used.

Demodulation Reference Signal (DMRS)

Sounding Reference Signal (SRS)

Parameters used to configure the physical channel and/or physical signal to the downlink and/or uplink described above may be notified, through physical layer signaling (e.g., PDCCH) and/or higher layer signaling RRC signaling, MAC CE, system information), from the base station apparatus to the terminal apparatus for configuration.

In the uplink, the Physical Uplink Shared Channel (PUSCH), the Physical Uplink Control Channel (PUCCH), and the like are allocated. The Uplink Reference Signal (ULRS) is also allocated along with the PUSCH or PUCCH. An uplink radio frame is constituted of uplink RB pairs. This uplink RB pair is a unit for allocation of an uplink radio resource and the like and is constituted by a frequency domain of a predefined width (RB bandwidth) and a predefined time domain (two slots=1 subframe). Each of the uplink RB pairs is constituted of two uplink RBs (RB bandwidth×slot) that are contiguous in the time domain. Each of the uplink RB is constituted of 12 subcarriers in the frequency domain. In the time domain, the uplink RB is constituted of seven SC-FDMA symbols in a case that an NCP is added, while the uplink RB is constituted of six SC-FDMA symbols in a case that an ECP is added. Note that although an uplink subframe in a single CC is described here, an uplink subframe may be defined for each CC.

FIG. 1 and FIG. 2 illustrate the example in which the different physical channels/physical signals are frequency-division multiplexed (FUM) and/or time-division multiplexed (TDM).

In a case that various physical channels and/or physical signals are transmitted for the sTTI (short/shorter/shortened Transmission Time Interval), each physical channel and/or physical signal may be referred to as the sPDSCH, sPDCCH, sPUSCH, sPUCCH, or sPRACH.

In the case that the physical channel is transmitted for the sTTI, the number of OFDM symbols and/or SC-FDMA symbols constituting the physical channel may be the number of symbols equal to or less than 14 symbols for the NCP (12 symbols for the ECP). The number of symbols used for the physical channel for the sTTI may be configured using the DCI and/or DCI format, or configured using higher layer signaling. Not only the number of symbols used for the sTTI but also a start symbol in direction may be configured.

The sTTI may be transmitted within a particular bandwidth in a system bandwidth. As bandwidth configured as a sTTI may be configured using the DCI and/or DCI format, or configured using higher layer signaling (RRC signaling, MAC CE). The bandwidth may be configured using start and end resource block indexes or frequency positions, or configured using the bandwidth and the start resource block index/frequency position. The bandwidth to which the sTTI is mapped may be referred to as a sTTI band. The physical channel mapped in the sTTI band may be referred to as the physical channel for the sTTI. The physical channel for the sTTI may include the sPDSCH, sPDCCH, sPUSCH, sPUCCH, and sPRACH.

In a case that the information/parameters used to define the sTTI are configured using the DCI and/or DCI format, those DCI and/or DCI format may be scrambled with a particular RNTI, or a CRC scrambled with a particular RNTI may be added to a bit sequence constituting the DCI format.

Here, the downlink physical channel and the downlink physical signal are also collectively referred to as a downlink signal. The uplink physical channel and the uplink physical signal are also collectively referred to as an uplink signal. The downlink physical channels and the uplink physical channels are also collectively referred to as a physical channel. The downlink physical signals and the uplink physical signals are also collectively referred to as a physical signal.

The PBCH is used for broadcasting a Master Information Block (MIB, a Broadcast Channel (BCH)) that is shared by the terminal apparatuses.

The PCFICH is used for transmitting, to the terminal apparatus (UE) and a relay station device (RN), information indicating a region (the number of OFDM symbols) to be used for PDCCH transmission. The PCFICH is transmitted on all the downlink subframes or the special subframe.

The PHICH is used to transmit a HARQ indicator (HARQ feedback or response information) indicating an ACKnowledgement (ACK) or a Negative ACKnowledgement (NACK) for the uplink data (Uplink Shared Channel (UL-SCH)) received by the base station apparatus (eNB). Specifically, the PHICH is used to transmit a HARQ-ACK (ACK/NACK) in response to the uplink transmission.

The PDCCH, the EPDCCH, and the sPDCCH are used for transmitting the downlink control information (DCI) and/or sidelink control information (SCI). In the present embodiment, the PDCCH may include the EPDCCH. The PDCCH may include the sPDCCH.

Here, multiple DCI formats may be defined for the DCI transmitted on the PDCCH, EPDCCH, and/or sPDCCH. A field for the DCI defined in the DCI format may be mapped to a prescribed information bit.

Here, the DCI format and/or SCI format may be defined for the SCI transmitted on the PDCCH, EPDCCH, and/or sPDCCH. A field for the SCI defined in the DCI format and/or SCI format may be mapped to a prescribed information bit.

In a case that the physical channel for the sTTI can be transmitted in a certain serving cell, that is, in the terminal apparatus and the base station apparatus in a certain serving cell, the terminal apparatus may monitor the PDCCH/EPDCCH/sPDCCH to which the DCI format (field defined in the DCI format) and/or the SCI format (field defined in the SCI format) which include the information/parameters for configuring the sTTI, are mapped. Specifically, the base station apparatus may map the DCI format and/or SCI format including the information/parameters for configuring the sTTI to the PDCCH/EPDCCH/sPDCCH and transmit the PDCCH/EPDCCH/sPDCCH to the terminal apparatus supporting the transmission and/or reception of the physical channel using the sTTI.

Here, the DCI format for the downlink is also referred to as downlink DCI, downlink grant (DL grant), and/or downlink scheduling grant, and/or downlink assignment. The DCI format for the uplink is also referred to as uplink DCI, uplink grant (UL grant), and/or uplink scheduling grant, and/or uplink assignment. The SCI format for the sidelink is also referred to as sidelink grant (SL grant), and/or sidelink scheduling grant, and/or sidelink assignment.

For example, the DCI format used for scheduling one PDSCH in one cell (e.g., DCI format 1, DCI format 1A and/or DCI format 1C, or a first DL grant) may be defined as the downlink assignment.

The DCI format used for scheduling one PUSCH in one cell (e.g., DCI format 0 and/or DCI format 4, or a first UL grant) may be defined as the uplink grant.

The DCI format used for scheduling the Physical Sidelink Control Channel (PSCCH) and/or the Physical Sidelink Shared Channel (PSSCH) (e.g., DCI format 5 or a first SL grant) may be defined as the sidelink grant. The sidelink grant may include some fields (e.g., frequency hopping flag, resource block assignment, time resource pattern) which are defined in the SCI format used for the PSSCH scheduling (e.g., SCI format 0 or a second SL grant).

In a case that the capability of changing the mapping pattern for the sidelink physical channel, based on a terminal apparatus speed is supported in the terminal apparatus and/or the base station apparatus, the sidelink grant may include a field indicating the mapping pattern, or a field indicating a particular resource pool list and/or resource pools included in a particular configuration. The DCI format including these fields (at least one of these fields) may be referred to as DCI format 5B.

Here, in a case that a PDSCH resource is scheduled by using the downlink assignment, the terminal apparatus may receive downlink data (DL-SCH) on the PDSCH, based on the scheduling. In a case that a PUSCH resource is scheduled by using the uplink grant, the terminal apparatus may transmit uplink data (UL-SCH) and/or uplink control information (UCI) by using the PUSCH, based on scheduling. In a case that a sPUSCH resource is scheduled by using the uplink grant, the terminal apparatus may transmit uplink data and/or uplink control information on the sPUSCH, based on the scheduling.

The sPDSCH may be scheduled in accordance with the first DL grant detected in the PDCCH and/or EPDCCH, and the second DL grant detected in the sPDCCH. Both the first DL grant and the second DL grant may be scrambled with a particular RNTI.

The sPDCCH may be configured with a region for monitoring the sPDCCH, based on the DCI included in the first DL grant detected in the PDCCH and/or EPDCCH (i.e., sTTI band for downlink).

For the sPUCCH, a resource may be determined based on the DCI included in the second DL grant detected in the sPDCCH.

The terminal apparatus may monitor a set of PDCCH candidates, EPDCCH candidates, and/or sPDCCH candidates. Hereinafter, the PDCCH may include an EPDDCH and/or a sPDCCH.

Here, the PDCCH candidates may indicate candidates of the PDCCH which may be possibly mapped and/or transmitted by the base station apparatus. Furthermore “monitoring” may imply that the terminal apparatus attempts to decode each PDCCH in the set of PDCCH candidates in accordance with each of all the monitored DCI formats.

Here, the set of PDCCH candidates to be monitored by the terminal apparatus is also referred to as a search space. The search space may include a common search space (CSS). For example, the CSS may be defined as a space common to multiple terminal apparatuses.

The search space may include a UE-specific search space (USS). For example, the USS may be provided at least based on a C-RNTI assigned to the terminal apparatus. The terminal apparatus may monitor the PDCCHs in the CSS and/or USS to detect a PDCCH destined for the terminal apparatus itself.

An RNTI assigned to the terminal apparatus by the base station apparatus is used for the transmission of the DCI (transmission on the PDCCH). Specifically, Cyclic Redundancy Check (CRC) parity bits are attached to the DCI format (or the downlink control information), and after the attaching, the CRC parity bits are scrambled with the RNTI. Here, the CRC parity bits attached to the DCI format may be obtained from a payload of the DCI format.

Here, in the present embodiment, the “CRC parity bits”, the “CRC bits”, and the “CRC” may be the same as each other. The “PDCCH on which the DCI format with the attached CRC parity bits is transmitted”, the “PDCCH including the CRC parity bits and including the DCI format”, the “PDCCH including the CRC parity bits”, and the “PDCCH including the DCI format” may be the same as each other. The “PDCCH including X” may be the same as the “PDCCH with X”. The terminal apparatus may monitor the DCI format. The terminal apparatus may monitor the DCI. The terminal apparatus may monitor the PDCCH.

The terminal apparatus attempts to decode the DCI format to which the CRC parity bits scrambled with the RNTI are attached, and detects, as a DCI format destined for the terminal apparatus itself, the DCI format for which the CRC has been successful (also referred to as blind coding). In other words, the terminal apparatus may detect the PDCCH with the CRC scrambled with the RNTI. The terminal apparatus may detect the PDCCH including the DCI format to which the CRC parity bits scrambled with the RNTI are attached.

The RNTI may include a Cell-Radio Network Temporary Identifier (C-RNTI). For example, the C-RNTI may be an identifier unique to the terminal apparatus and used for the identification in RRC connection and scheduling. The C-RNTI may be used for dynamically scheduled unicast transmission.

The RNTI may further include a Semi-Persistent Scheduling C-RNTI (SPS C-RNTI). For example, the SPS C-RNTI is an identifier unique to the terminal apparatus and used for semi-persistent scheduling. The SPS C-RNTI may be used for semi-persistently scheduled unicast transmission. Here, the semi-persistently scheduled transmission may include meaning of periodically scheduled transmission.

The RNTI may include a Random Access RNTI (RA-RNTI). For example, the RA-RNTI may be an identifier used for transmission of a random access response message. In other words, the RA-RNTI may be used for the transmission of the random access response message in a random access procedure. For example, the terminal apparatus may monitor the PDCCH with the CRC scrambled with the RA-RNTI in a case that a random access preamble is transmitted. The terminal apparatus may receive a random access response on the PDSCH in accordance with detection of the PDCCH with the CRC scrambled with the RA-RNTI.

The RNTI may include a Sidelink RNTI (SL-RNTI). For example, the SL-RNTI may be used for sidelink transmission dynamically scheduled, that is, scheduled using L1 signaling (PDCCH, EPDCCH, sPDCCH). For example, the terminal apparatus may monitor the PDCCH with the CRC scrambled with the SL-RNTI in a case of the sidelink transmission.

In a case that the terminal apparatus is configured to receive the DCI format with the CRC scrambled with the Sidelink RNTI (SL-RNTI), the terminal apparatus may decode the PDCCH in the CSS and USS based on the C-RNTI and/or the EPDCCH in the USS based on the C-RNTI.

Here, the PDCCH with the CRC scrambled with the C-RNTI may be transmitted in the USS or CSS. The PDCCH with the CRC scrambled with the SPS C-RNTI may be transmitted in the USS or CSS. The PDCCH with the CRC scrambled with the RA-RNTI may be transmitted only in the CSS.

Examples of the RNTI with which the CRC is scrambled include the RA-RNTI, C-RNTI, SPS C-RNTI, temporary C-RNTI, eIMTA-RNTI, TPC-PUCCH-RNTI, TPC-PUSCH-RNTI, M-RNTI, P-RNTI, SI-RNTI, and SL-RNTI.

The RA-RNTI, C-RNTI, SPS C-RNTI, eIMTA-RNTI, TPC-PUCCH-RNTI, and TPC-PUSCH-RNTI are configured for the terminal apparatus by the base station apparatus through higher layer signaling.

The M-RNTI, P-RNTI, and SI-RNTI correspond to one value. For example, the P-RNTI corresponds to the PCH and the PCCH, and is used to notify of paging and a change in the system information. The SI-RNTI corresponds to the DL-SCH and the BCCH, and is used to broadcast the system information. The RA-RNTI corresponds to the DL-SCH, and is used for the random access response.

The RA-RNTI, SPS C-RNTI, temporary C-RNTL eIMTA-RNTI, TPC-PUCCH-RNTI, and TPC-PUSCH-RNTI are configured using higher layer signaling.

A prescribed value is defined for each of the M-RNTI, P-RNTI, and SI-RNTI.

The PDCCHs with the CRC scrambled with the respective RNTIs may be different in the corresponding transport channel or logical channel depending on the value of the RNTI. Specifically, the indicated information may be different depending on the value of the RNTI.

One SI-RNTI is used to address SIB similar to the all SI messages.

The PDSCH is used to transmit downlink data (Downlink Shared Channel (DL-SCH)). The PDSCH is used to transmit a system information message. Here, the system information message may be cell-specific information. The system information may be included in RRC signaling. The PDSCH may be used to transmit the RRC signaling and the MAC control element.

The PMCH is used to transmit multicast data (Multicast Channel (MCH)).

The synchronization signal is used for the terminal apparatus to take synchronization in the frequency domain and the time domain in the downlink. In the TDD scheme, the synchronization signal is mapped to subframes 0, 1, 5, and 6 within a radio frame. In the FDD scheme, the synchronization signal is mapped to subframes 0 and 5 within a radio frame.

The downlink reference signal is used for the terminal apparatus to perform channel compensation on a downlink physical channel. The downlink reference signal is used in order for the terminal apparatus to calculate the downlink channel state information.

The DS is used for time-frequency synchronization, cell identification, and Radio Resource Management (RRM) (intra- and/or inter-frequency measurement) in the frequency configured with parameters for the DS. The DS is constituted by multiple signals, and those signals are transmitted with the same periodicity. The DS is constituted using resources in the PSS/SSS/CRS, and further may be constituted using CSI-RS resources. In the DS, RSRP or RSRQ may be measured using the resource to which the CRS or the CSI-RS is mapped.

The BCH, MCH, UL-SCH, and DL-SCH are the transport channels. Channels used in the medium access control (MAC) layer are referred to as the transport channels. A unit of the transport channel used in the MAC layer is also referred to as a transport block (TB) or a MAC Protocol Data Unit (PDU). A Hybrid Automatic Repeat reQuest (HARQ) is controlled for each transport block in the MAC layer. The transport block is a unit of data that the MAC layer delivers to the physical layer. In the physical layer, the transport block is mapped to a codeword, and a coding process is performed for each codeword.

The PUCCH and/or sPUCCH is used to transmit (or feed back) the uplink control information (UCI). Hereinafter, the PUCCH may include the sPUCCH. Here, the UCI may include channel state information (CSI) used to indicate a downlink channel state. The UCI may include a scheduling request (SR) used to request an UL-SCH resource. The UCI may include Hybrid Automatic Repeat request ACKnowledgment (HARQ-ACK).

Here, HARQ-ACK may indicate HARQ-ACK for downlink data (Transport block, Medium Access Control Protocol Data Unit (MAC PDU), Downlink-Shared Channel (DL-SCH), or Physical Downlink Shared Channel (PDSCH)). In other words, HARQ-ACK may indicate ACKnowledgment (ACK, positive-acknowledgement) or Negative-acknowledgment (NACK) for the downlink data. The CSI may include a channel quality indicator (CQI), a precoding matrix indicator (PMI), and/or a rank indication (RI). HARQ-ACK may be referred to as a HARQ-ACK response.

The PUCCH and/or the sPUCCH may be configured with a format depending on a type or combination of the transmitted (reported) UCI. Hereinafter, the PUCCH may include the sPUCCH.

For example, a PUCCH format to transmit a positive SR may be defined.

For example, a PUCCH format to transmit a positive SR and/or HARQ-ACK may be defined.

For example, a PUCCH format to transmit HARQ-ACK of one or more bits may be defined.

For example, a PUCCH format to transmit the CSI for one or more serving cells may be defined. The PUCCH format may be different depending on the number of serving cells.

For example, a PUCCH format to transmit the HARQ-ACK and/or CSI may be defined.

The number of symbols or the number of resource elements (resource blocks) allocated to the PUCCH may be different within one subframe and/or one TTI depending on the type of the PUCCH format.

A cyclic; shift value may be configured for each PUCCH format.

The PUSCH and/or sPUSCH is used to transmit uplink data (Uplink-Shared Channel (UL-SCH)). Hereinafter, the PUSCH may include the sPUSCH. The PUSCH may be also used to transmit HARQ-ACK and/or CSI along with the uplink data. Furthermore, the PUSCH may be used to transmit CSI only or HARQ-ACK and CSI only. In other words, the PUSCH may be used to transmit the UCI only.

Here, the base station apparatus and the terminal apparatus may exchange (transmit and/or receive) signals with each other in their respective higher layers. For example, the base station apparatus and the terminal apparatus may transmit and/or receive RRC signaling (also referred to as RRC message or RRC information) in a Radio Resource Control (RRC) layer. The base station apparatus and the terminal apparatus may communicate (transmit and/or receive) a Medium Access Control (MAC) control element in a MAC layer, respectively. Here, the RRC signaling and/or the MAC control element is also referred to as higher layer signaling.

In the present embodiment, the phrase that “the CP is attached to the OFDM symbol and/or SC-FDMA symbol” may be synonymous with the phrase that “a CP sequence is attached to a physical channel sequence transmitted using the OFDM symbol and/or SC-FDMA symbol.

In the present embodiment, “higher layer parameter”, “higher layer message”, “higher layer signaling”, “higher layer information”, and “higher layer information element” may be the same as each other.

The PUSCH may be used to transmit the RRC signaling and the MAC control element (MAC CE). Here, the RRC signaling transmitted from the base station apparatus may be signaling common to multiple terminal apparatuses in a cell. The RRC signaling transmitted from the base station apparatus may be signaling dedicated to a certain terminal apparatus (also referred to as dedicated signaling). In other words, user-equipment-specific information may be transmitted through signaling dedicated to the certain terminal apparatus.

The PRACH and/or sPRACH is used to transmit a random access preamble. Hereinafter the PRACH may include the sPRACH. For example, the PRACH (or random access procedure) is used in order mainly for the terminal apparatus to take synchronization in the time domain with the base station apparatus. The PRACH (or random access procedure) may be used for an initial connection establishment procedure, a handover procedure, a connection re-establishment procedure, uplink transmission synchronization (timing adjustment), and scheduling request (PUSCH resource request, UL-SCH resource request) transmission.

The DMRS is associated with the PUSCH, sPUSCH and/or PUCCH transmission. In other words, the DMRS is time-multiplexed with the PUSCH, sPUSCH and/or PUCCH. For example, the base station apparatus may use the DMRS in order to perform channel compensation of the PUSCH, sPUSCH and/or PUCCH. The DMRS may be different in time-multiplexed arrangement or the number of multiplexed DMRSs depending on the type of the physical channel to be demodulated.

The SRS is not associated with the PUSCH or PUCCH transmission. For example, the base station apparatus may use the SRS to measure an uplink channel state or transmission timing. Examples of the SRS include a trigger type 0 SRS transmitted in a case that the associated parameters are configured through higher layer signaling, and a trigger type 1 SRS transmitted in a case that the associated parameters are configured through higher layer signaling and transmission is requested by an SRS request included in the uplink grant.

Next, a description is given of sidelink transmission and sidelink reception according to the present embodiment. The sidelink reception can be achieved by a reverse procedure to the sidelink transmission, and therefore, a detailed description thereof is omitted. The sidelink transmission is transmission in the sidelink. The sidelink reception is reception in the sidelink. The sidelink is a link (interface) between the terminal apparatuses.

The sidelink transmission may be defined for sidelink discovery and sidelink communication between the terminal apparatuses (e.g., between a first terminal apparatus and a second terminal apparatus). Specifically, the sidelink transmission may include at least one of the sidelink discovery and the sidelink communication. In a case that the terminal apparatus (terminal apparatus capable of the sidelink transmission) is within a network coverage, the sidelink transmission uses a frame structure the same as the frame structure defined for the uplink and downlink. However, the sidelink transmission is limited to a subset of uplink resources in the time domain and the frequency domain. Specifically, the sidelink transmission is performed using the resource for the uplink transmission. The terminal apparatus being within a network coverage capable of the sidelink transmission is referred to as in-coverage. The terminal apparatus being without a network coverage capable of the sidelink transmission is referred to as out-of-coverage. For example, in a case that the terminal apparatus can detect a network (cell), the terminal apparatus may determine that the terminal apparatus itself is an in-coverage apparatus. For example, in a case that the terminal apparatus fails to detect a network (cell), the terminal apparatus may determine that the terminal apparatus itself is an out-of-coverage apparatus. The sidelink transmission may be referred to as the sidelink.

The sidelink transmission may use a transmission scheme the same as the uplink transmission. In the sidelink, transmissions of the all sidelink physical channels may be limited to one cluster transmission. In the sidelink transmission, a 1-symbol gap may be used at the end of each sidelink subframe (that is, a tail end symbol). The tail end symbol of each sidelink subframe is not used to the sidelink transmission.

The following sidelink physical channels may be used for sidelink radio communication between a terminal apparatus and another terminal apparatus. Here, the sidelink physical channels are used to transmit the information output from the higher layers.

Physical Sidelink Shared Channel (PSSCH)

Physical Sidelink Control Channel (PSCCH)

Physical Sidelink Discovery Channel (PSDCH)

Physical Sidelink Broadcast Channel (PSBCH)

The following sidelink physical signals may be used for sidelink radio communication between a terminal apparatus and another terminal apparatus. Here, the sidelink physical signal does not transmit information output from the higher layers.

Synchronization signal

Demodulation Reference Signal (DMRS)

Here, the sidelink physical channels and the sidelink physical signals are also collectively referred to as a sidelink signal.

Parameters used to configure the physical channel and/or physical signal to the sidelink described above may be notified, through physical layer signaling (e.g., PDCCH, PSCCH, PSBCH) and/or higher layer signaling (e.g., RRC signaling, MAC CE, system information), from the base station apparatus and/or terminal apparatus to another terminal apparatus for configuration.

The resource element in a tail end SC-FDMA symbol in the subframe is counted in a mapping process on each of the PSSCH, PSCCH, PSDCH, and PSBCH. However, the PSSCH, PSCCH, PSDCH, and PSBCH are not transmitted.

The PSSCH is used to transmit data for the sidelink communication from the terminal apparatus (data information, Sidelink Shared Channel (SL-SCH)).

The PSCCH is used to transmit control (control information, SCI) for the sidelink communication from the terminal apparatus. The PSCCH is used to indicate the resource for the PSSCH used by the terminal apparatus and other parameters for the PSSCH. The PSCCH is mapped to a sidelink control resource.

The SCI is used to transport the sidelink scheduling information for one Destination ID (DST-ID). A field for the SCI is defined in the SCI format. The SCI is mapped to a prescribed information bit.

SCI format 0 is used for scheduling of the PSSCH. By using SCI format 0, the frequency hopping, resource block assignment and hopping resource allocation, time resource pattern, Modulation and Coding Scheme (MCS), Timing Advance Indication (TAI), ad Group Destination ID (G-DST-ID) are transmitted.

In a case that the capability of changing the mapping pattern in the resource pool based on the terminal apparatus speed is supported by the terminal apparatus, a field indicating the mapping pattern may be included in the SCI format. The SCI format including this field may be referred to as SCI format 0B.

SCI format 0B and/or DCI format 5B may include a CRC scrambled with a RNTI configured for a terminal apparatus mounted on a vehicle.

In a case that the capability of changing the mapping pattern in the resource pool based on the terminal apparatus speed is supported in the terminal apparatus, another terminal apparatus and/or the base station apparatus, the mapping pattern indicated by the field indicating the mapping pattern included in DCI format 5 (5B) and/or SCI format 0 (0B) may correspond to the system information including the configuration for the resource pool and/or higher layer signaling. For example, the field indicating the mapping pattern may be a field switching between the resource pool for the system information for pedestrian sidelink transmission and reception, and the resource pool for the system information for vehicular sidelink transmission and reception.

The terminal apparatus detecting SCI format 0 on the PSCCH in sidelink transmission mode 1 can decode the PSSCH corresponding to detected SCI format 0. The terminal apparatus in sidelink transmission mode 1 may perform a transmission process on the PSCCH and/or PSSCH, based on the DCI format used for the PSCCH and/or PSSCH scheduling (e.g., DCI format 5 or a first SL grant). Here, the transmission process on the PSCCH and/or PSSCH may include the mapping process on the PSCCH and/or PSSCH, and selecting the resource (resource pool).

The terminal apparatus detecting SCI format 0 on the PSCCH in sidelink transmission mode 2 can decode the PSSCH corresponding to the associated PSSCH resource configuration configured by the higher layer and detected SCI format 0. The terminal apparatus in sidelink transmission mode 2 may perform the transmission process on the PSCCH and/or PSSCH independently from the DCI format used for the PSCCH and/or PSSCH scheduling (e.g., DCI format 5 or the first SL grant). Here, the transmission process on the PSCCH and/or PSSCH may include the mapping process on the PSCCH and/or PSSCH, and selecting the resource (resource pool).

The PSCCH is used to transmit a sidelink discovery message from the terminal apparatus.

The PSBCH is used to transmit information of the system and synchronization transmitted from the terminal apparatus. The PSBCH may include information of the speed of the terminal apparatus transmitting the PSBCH.

In a case that the transmission and/or reception using the sTTI is applied to (or supported for) each of the PSSCH, PSCCH, PSDCH, and PSBCH, the PSSCH, PSCCH, PSDCH, and PSBCH for the sTTI may be referred to as sPSSCH, sPSCCH, sPSDCH, and sPSBCH, respectively. Hereinafter, the PSSCH, the PSCCH, the PSDCH, and the PSBCH may include the sPSSCH, the sPSCCH, the sPSDCH, and the sPSBCH, respectively.

The synchronization signal in the sidelink includes a Primary Sidelink Synchronization Signal (PSSS) and a Secondary Sidelink Synchronization Signal (SSSS). The SL-ID may be indicated by detecting the PSSS and the SSSS.

The PSSS may be transmitted in two adjacent SC-FDMA symbols in the same subframe.

Each of two sequences used for the PSSS in two SC-FDMA symbols may be provided by a certain route index. In a case that the sidelink ID (SL-ID) is 167 or less, the route index is 26, and otherwise, the route index is 37.

The sequence for the PSSS is mapped to a resource element at an antenna port 1020 of a first slot in a certain subframe. The sequence for the PSSS is mapped to symbol 1 and symbol 2 (the second symbol and the third symbol in the slot) of a first slot in a certain subframe in a case of the NCP, and symbol 0 and symbol 1 (the first symbol and the second symbol in the slot) of a first slot in a certain subframe in a case of the ECP.

The SSSS is transmitted in two adjacent SC-FDMA symbols in the same subframe.

Each of two sequences used for the SSSS is provided assuming that a first ID (n⁽¹⁾_{ID}, a second ID (n⁽²⁾_{ID}), and subframe 0. The first ID is provided with a remainder of dividing the SL-ID by 168. The second ID is provided by a floor function of SL-ID/168 (i.e., by applying a floor function to a quotient of dividing the SL-ID by 168).

The sequence for the SSSS is mapped to a resource element at an antenna port 1020 of a second slot in a certain subframe. The sequence for the SSSS is mapped to symbol 4 and symbol 5 of a second slot in a certain subframe in the case of the NCP, and symbol 3 and symbol 4 of a second slot in a certain subframe in a case of the ECP.

The sidelink synchronization signal (that is, PSSS and SSSS) may be transmitted by the terminal apparatus and/or base station apparatus supporting the sidelink transmission. The terminal apparatus may receive the signal assuming that the signal is transmitted from another terminal apparatus and/or base station apparatus.

The terminal apparatus is not expected to detect, in blind detection, a CP length of the sidelink synchronization signal transmitted by another terminal apparatus.

The sidelink synchronization signal is transmitted using the subframe and/or TTI the same as the PSBCH.

The in-coverage terminal apparatus may transmit the PSSS/SSSS corresponding to the SL-ID being a value the same as the cell ID of the cell. The out-of-coverage terminal apparatus may transmit the PSSS/SSSS corresponding to the SL-ID being a value different from the cell ID of the cell. The SL-ID having a value different from the cell ID of the cell may be a known value predefined in the specification or the like.

The terminal apparatus may determine the SL-ID, based on the terminal apparatus speed. The terminal apparatus may determine a mapping processing method of the PSSS/SSSS, based on the terminal apparatus speed. The terminal apparatus may determine an index of the symbol to which the PSSS/SSSS is mapped and the number of symbols, based on the terminal apparatus speed.

In the present embodiment, the “TTI” may include the sTTI. Specifically, in the present embodiment, the “TTI” may include at least one TTI length. For example, the “TTI” may include a TTI constituted by two symbols, a TTI constituted by 14 symbols, or a TTI having a length other than these.

The DMRS (S-DMRS) in the sidelink is used to demodulate the PSDCH, the PSCCH, and the PSSCH. The S-DMRS is analogous to the DMRS that is one of the uplink reference signals. The S-DMRS is transmitted in the fourth symbol in the slot in the case of the NCP, and transmitted in the third symbol in the slot in the case of the ECP. A sequence length of the S-DMRS is the same as a size of the allocated resource (that is, the number of subcarriers).

A set of physical resource blocks used for a mapping process on the PSDCH/PSCCH/PSSCH/PSBCH transmission is defined in the same way as a set of physical resource blocks used for the mapping process on the PUSCH. Specifically, the mapping on the PSDCH/PSCCH/PSSCH/PSBCH transmission may be mapping the same as mapping of a PUSCH region in FIG. 2 and/or mapping with no PUCCH region.

An index k (index in the frequency direction) in the mapping process of the S-DMRS on the PSDCH/PSCCH/PSSCH/PSBCH transmission is defined in the same way as an index k of the mapping process of the DMRS on the PUSCH.

A pseudo-random sequence generator is initialized at the beginning of each slot satisfying that a slot number of the PSSCH is 0.

The S-DMRS is generated for the PSDCH and PSCCH based on fixed reference sequence, cyclic shift, and orthogonal cover code (OCC).

For an in-coverage operation, a power spectral density of the sidelink transmission may be configured by the base station apparatus. Specifically, in the in-coverage operation, the base station apparatus may configure power control parameters regarding the sidelink transmission for the terminal apparatus supporting the sidelink transmission to transmit the parameters through higher layer signaling.

For measurement in the sidelink, Sidelink Reference Signal Received Power (S-RSRP) and/or Sidelink Discovery RSRP (SD-RSRP) may be supported as a measurement amount on the terminal apparatus side.

The S-RSRP is defined as a linear average (or a linear average value) of an electrical power value (Power Contribution expressed by [W]) of the resource element for transmitting the DMRS associated with the PSBCH in center 6 PRB of an applicable subframe. Specifically, the S-RSRP may be an average receive power of the DMRS associated with the PSBCH.

The SD-RSRP is defined as a linear average (or a linear average value) of an electrical power value (Power Contribution expressed by [W]) of the resource element for transmitting the DMRS associated with the PSDCH with the valid CRC. Specifically, the SD-RSRP may be an average receive power of the DMRS associated with the PSDCH.

The resource pool list is configured for each of the sidelink communication and the sidelink discovery, and the terminal apparatus selects a resource pool (that is, the configuration for the resource pool) from the corresponding resource pool list and transmits the selected resource pool.

The SIB corresponding to the sidelink communication (e.g., SIB 18 (System Information Block Type 18)) may include a configuration for the sidelink communication.

SIB 18 provides resource information on the sidelink synchronization signal and SBCCH transmission.

The configuration for the sidelink communication may include a resource pool list used for reception, a resource pool list used for transmission in a normal condition, a resource pool list used for transmission in an exception condition, and a configuration for synchronization, for the sidelink communication.

The SIB corresponding to the sidelink discovery (e.g., SIB 19 (System Information Block Type 19)) may include a configuration for the sidelink discovery.

The configuration for the sidelink discovery may include a resource pool list used for reception, a resource pool list used for transmission information of a transmit power, and a configuration for synchronization, for the sidelink discovery.

The resource pool list may include the configuration for one or more resource pools.

The configuration for the resource pool may include the CP length, a periodicity with which a resource mapped to the sidelink, a configuration for a time frequency resource, a CP length for data, a hopping configuration for data, a resource configuration selected by the terminal apparatus, and parameters used for reception.

The configuration for a time frequency resource may include the number of physical resource blocks (PRBs), the PRB start index, the PRB end index, an offset indicator, and a subframe bitmap.

The configuration for synchronization may include a CP length used for the sidelink synchronization signal, a sidelink synchronization signal ID, parameters used for transmission, and parameters used for reception. The parameters used for transmission may be parameters used to set the transmit power. The parameters used for reception may be parameters indicating a receive window.

The configuration for the sidelink communication and/or the configuration for the sidelink discovery may be transmitted through higher layer signaling and configured for the terminal apparatus supporting the sidelink communication and/or the sidelink discovery. The configuration for the sidelink communication may include a configuration with the same content as the configuration included in the SIB corresponding to the sidelink communication. The configuration for the sidelink discovery may include a configuration with the same content as the configuration included in the SIB corresponding to the sidelink discovery.

In a case that the terminal apparatus is an out-of-coverage apparatus, the parameters configured in advance for the terminal apparatus may be used to perform the sidelink transmission. In a case that the terminal apparatus is an in-coverage apparatus, the parameters configured via the SIB or through higher layer signaling may be used to perform the sidelink transmission.

In order to synchronize with the out-of-coverage operation, the terminal apparatus transmits the PSBCH including the Sidelink Broadcast Control Channel (SBCCH) and the sidelink synchronization signal to act as a synchronization source. The SBCCH transmits system information necessary for receiving another sidelink channel and signal. The SBCCH with the sidelink synchronization signal is transmitted with a fixed periodicity of 40 ms. The SBCCH is a logical channel. The phrase “transmitting the SBCCH” may be synonymous with the phrase “transmitting the PSBCH including the SBCCH”.

There are two subframes for every 40 ms configured in advance for the out-of-coverage operation. The terminal apparatus receives the sidelink synchronization signal and the SBCCH in a certain subframe. In a case that the terminal apparatus is a synchronization source, the terminal apparatus transmits the sidelink synchronization signal and the SBCCH in another subframe.

The terminal apparatus receives the sidelink synchronization signal and the SBCCH (the PSBCH including the SBCCH) in one subframe.

In a case that the terminal apparatus is within the network coverage, the content of the SBCCH transmitted by the terminal apparatus within the network coverage may be acquired from the parameter signaled by the base station apparatus. In a case that the terminal apparatus is an out-of-coverage apparatus, and another terminal apparatus is selected as a synchronization source, the content of the SBCCH transmitted by the out-of-coverage terminal apparatus may be acquired from the SBCCH received from another terminal apparatus. Otherwise (that is, in a case that the terminal apparatus is an out-of-coverage apparatus, and another terminal apparatus is not selected as a synchronization source), the content of the SBCCH transmitted by the out-of-coverage terminal apparatus is provided based on the parameters configured in advance for the terminal apparatus.

The terminal apparatus performs the sidelink communication in a subframe defined during a sidelink control period. The sidelink control period is a period over which resources are allocated in a cell for sidelink control information (that is, the PSCCH including the sidelink control information) and sidelink data transmissions (that is, the PSSCH including the sidelink data). During the sidelink control period, the terminal apparatus transmits the sidelink control information following the sidelink data. The sidelink control information indicates a L1-ID and transmission characteristics (e.g., the MCS, the resource allocation during the sidelink control period, the timing adjustment). The L1-ID may be a DST-ID or a G-DST-ID.

The terminal apparatus may be configured with one or more resource configurations for the PSSCH by the higher layers. The resource configuration for the PSSCH may be used for PSSCH reception or PSSCH transmission.

The resource configuration may be referred to as the configuration for the resource pool.

The terminal apparatus may be configured with the resource configuration for one or more PSCCHs by the higher layers. The resource configuration for the PSCCH may be used for PSCCH reception or PSCCH transmission. The resource configuration for the PSCCH may be associated with sidelink transmission mode 1 or sidelink transmission mode 2.

The terminal apparatus detecting SCI format 0 on the PSCCH in sidelink transmission mode 1 may decode the PSSCH corresponding to detected SCI format 0.

The terminal apparatus detecting SCI format 0 on the PSCCH in sidelink transmission mode 2 may decode the PSSCH corresponding to detected SCI format 0 and the resource configuration for the associated PSSCH configured by the higher layers.

The terminal apparatus configured, by the higher layers, to detect SCI format 0 on the PSCCH for each of the resource configurations for the PSCCHs associated with sidelink transmission mode 1 and/or sidelink transmission mode 2 may use the G-DST-ID indicated by the higher layers to try to decode the PSSCH corresponding to the resource configuration for the PSCCH.

The terminal apparatus may be configured with the resource configuration for one or more PSDCHs by the higher layers. The resource configuration for the PSDCH may be used for PSDCH reception or PSDCH transmission. The PDSCH transmission corresponding to the resource configuration for the PSCCH may be associated with sidelink discovery type 1 or sidelink discovery type 2.

The terminal apparatus configured, by the higher layers, to detect a transport block on the PSDCH for each of the resource configurations for the PSDCHs associated with the PSDCH reception for sidelink discovery type 1 and/or sidelink discovery type 2B may decode the PSDCH corresponding to the resource configuration for the PSDCH.

Except for a case of the SSSS transmission, the sidelink transmission power does not vary in the sidelink subframe. The transmit powers for the sidelink physical channel and associated DMRS transmitted in the same subframe are the same as each other. The transmit powers for the PSSS and PSBCH transmitted in the same subframe are the same as each other.

The terminal apparatus does not expect the resource configuration for such a PSCCH that the number of resource blocks in a resource block pool indicated by the resource configuration for the PSCCH in a particular subframe exceeds 50.

A time unit Tₛ in the LTE is based on a subcarrier spacing (e.g., 15 kHz) and an FFT size (e.g., 2048). Specifically, Tₛ is 1/(15000×2048) seconds. A time length of one slot is 15360×Tₛ (that is, 0.5 ms). A time length of one subframe is 30720×Tₛ (that is, 1 ms). A time length of one radio frame is 307200×Tₛ (that is, 10 ms).

The scheduling of a physical channel or physical signal is managed by using a radio frame. The time length of one radio frame may be 10 milliseconds (ms). One radio frame may include 10 subframes. One subframe may include two slots. Specifically, the time length of one subframe may be 1 ms, and the time length of one slot may be 0.5 ms. Moreover, scheduling may be managed by using a resource block as a minimum unit of scheduling for allocating a physical channel. The “resource block” may be defined by a given frequency domain constituted of a set of multiple subcarriers (e.g., 12 subcarriers) on a frequency axis and a domain (time domain) constituted of a given transmission time interval (TTI, slot, symbol). One subframe may be referred to as one resource block pair.

One TTI may be defined as one subframe or the number of symbols constituting one subframe. For example, in the case of the Normal Cyclic Prefix (NCP), one TTI may be constituted by 14 symbols. In the case of the Extended CP (ECP), one TTI may be constituted by 12 symbols. The TTI may be defined as a reception time interval on the reception side. The TTI may be defined as a unit of transmission or unit of reception for a physical channel or a physical signal. Specifically, the time length of a physical channel or physical signal may be defined based on a length of the TTI. The symbol may include a SC-FDMA symbol and/or an OFDM symbol. The length of the TTI (TTI length) may be represented by the number of symbols. The TTI length may be represented by a time length such as millisecond (ms) or microsecond (μs).

A sequence relating to a physical channel and/or physical signal is mapped to each symbol. The CP is attached to a sequence relating to a physical channel and/or physical signal in order to improve accuracy of detecting the sequence. The CP includes an NCP and an ECP, and a length of the attached sequence of the ECP is longer compared with the NCP. The sequence length relating to the CP may be referred to as a CP length.

In a case that the terminal apparatus and the base station apparatus support a function associated with Latency Reduction (LR), one TTI may include symbols less than 14 symbols for the NCP (12 symbols for the ECP). For example, the TTI length of one TTI may correspond to two, three or seven symbols. The TTI includes the symbols less than 14 symbols for the NCP (12 symbols for the ECP) may be referred to as a sTTI (short TTI, shorter TTI, shortened TTI).

The TTI having the TTI length of 14 symbols for the NCP (12 symbols for the ECP) may be referred to merely as the TTI.

The TTI lengths of the sTTI (DL-sTTI) for the downlink transmission may be configured to be any of two symbols and seven symbols. The TTI lengths of the sTTI (UL-sTTI) for the uplink transmission may be configured to be any of two symbols, three or four symbols, and seven symbols. The sPDCCH and the sPDSCH may be allocated in the DL-sTTI. The TTI length for the sPUSCH, sPUCCH, and sPRACH may be individually configured. The TTI length for the sPDSCH may include a sPDCCH symbol or a PDCCH symbol. The TTI length for the sPUSCH and/or sPUCCH may include a DMRS symbol or an SRS symbol.

The subcarrier spacing for each of the various physical channels and/or physical signals described above may be individually defined/configured for each of the physical channels and/or physical signals. The time length of one symbol for each of the various physical channels and/or physical signals may be individually defined/configured for each of the physical channels and/or physical signals. Specifically, the TTI length for each of the various physical channels and/or physical signals may be individually defined/configured for each of the physical channels and/or physical signals.

In the present embodiment, Carrier Aggregation (CA) may be performed in which multiple cells (component carriers corresponding to the cells) are used to perform communication. In the CA, the cell includes a primary cell (PCell) for establishing an initial access or RRC connection, and a secondary cell added/changed/deleted/activated-deactivated using the primary cell.

In the present embodiment, Dual Connectivity (DC) may be performed in which multiple cells (component carriers corresponding to the cells) are used to perform communication. In the DC, cells belonging to each of two base station apparatuses (Master eNB (MeNB), Secondary eNB (SeNB)) constitute a group. A cell group of cells belonging to the MeNB and including the primary cell is defined as a Master Cell Group (MCG), and a cell group of cells belonging to the SeNB and including the primary secondary cell (PSCell) is defined as a Secondary Cell Group (SCG). The primary secondary cell is a cell group not including the primary cell in a case that multiple cell groups are configured, that is, a cell having the same function as the primary cell (the secondary cell, a serving cell other than the primary cell) in the SCG.

The primary cell and the primary secondary cell serve as the primary cell in each CG. Here, the primary cell may be a cell where the PUCCH and/or a control channel corresponding to PUCCH can be transmitted and/or allocated, a cell associated with an initial access procedure/RRC connection procedure/initial connection establishment procedure, a cell capable of triggering for a random access procedure by L1 signaling, a cell monitoring a radio link, a cell supporting semi-persistent scheduling, a cell detecting/determining the RLF, or a cell always activated. In the present embodiment, the cell having the function of the primary cell and/or primary secondary cell may be referred to as a special cell. The primary cell/primary secondary cell/secondary cell may be defined for the LR cell similarly to the LTE.

In an aspect of the present invention, the time domain may be represented by the time length or the number of symbols. The frequency domain may be represented by the bandwidth, the number of subcarriers, or the number of resource elements or the number of resource blocks in the frequency direction.

In the LR cell, a size of the TTI (TTI length) may be capable of being changed based on a subframe type, the configuration information of the higher layer, and the control information included in L1 signaling.

In the LR cell, a grant-free access may be possible. The grant-free access is an access not using the control information (DCI format, downlink grant, uplink grant) indicating the schedule of the PDSCH or the PUSCH (downlink or uplink shared channel/data channel). Specifically, an access scheme not performing dynamic resource allocation or transmission indication using the PDCCH (downlink control channel) may be applied to the LR cell.

In the LR cell, the terminal apparatus may perform the HARQ-ACK and/or CSI feedback corresponding to the downlink resource (signal, channel) by using the uplink resource (signal, channel) mapped to the same subframe, based on the function (performance, capability) of the terminal apparatus and the configuration from the base station apparatus. In this subframe, a reference resource for the CSI for a CSI measurement result in a certain subframe may be the CRS or CSI-RS in the same subframe. Such a subframe may be referred to as a self-contained subframe.

The self-contained subframe may include one or more consecutive subframes, Specifically, the self-contained subframe may include multiple subframes, or may be one transmission burst including multiple subframes. A tail end subframe included in the self-contained subframe (a backward subframe including a tail end subframe) is preferably an uplink subframe or a special subframe. Specifically, the uplink signal/channel is preferably transmitted in this tail end subframe.

In a case that the self-contained subframe includes multiple downlink subframes and one uplink subframe or special subframe, a HARQ-ACK for each of those multiple downlink subframes may be transmitted in the UpPTS in one uplink subframe or special subframe.

The communication device determines an ACK or NACK for a signal based on whether or not the signal can have been received (demodulation/decode). An ACK indicates that the communication device has received the signal, and a NACK indicates that the communication device has failed to receive the signal. The communication device to which the NACK is fed back may retransmit the signal corresponding to the NACK. The terminal apparatus determines whether to retransmit the PUSCH based on content of the HARQ-ACK for the PUSCH transmitted from the base station apparatus. The base station apparatus determines whether to retransmit the PDSCH, based on content of the HARQ-ACK for the PDSCH or PDCCH/EPDCCH transmitted from the terminal apparatus. The ACK/NACK for the PUSCH transmitted by the terminal apparatus is fed back to the terminal apparatus by using the PDCCH or PHICH. The ACK/NACK for the PDSCH or PDCCH/EPDCCH transmitted by the base station apparatus is fed back to the base station apparatus by using the PUCCH or PUSCH.

In the present embodiment, the subframe indicates a unit of transmission and/or unit of reception for the base station apparatus and/or terminal apparatus. In the present embodiment, the TTI indicates a unit of transmission and/or unit of reception for the base station apparatus and/or terminal apparatus.

The base station apparatus may determine that the terminal apparatus is a Latency Reduction (LR) device, based on a Logical Channel ID (LCID) for a Common Control Channel (CCCH) and the capability information of the terminal apparatus (performance information, functional information).

The base station apparatus may determine that the terminal apparatus is a Next Generation (NR) device, based on the LCID for the CCCH and the capability information of the terminal apparatus.

In a case that the terminal apparatus and/or the base station apparatus support capabilities regarding the LR and/or NR, a processing time (processing delay, latency) may be determined based on the length of the TTI (the number of symbols) used for the receive signal and/or transmit signal. Specifically, the processing time of the terminal apparatus and/or base station apparatus supporting the capabilities regarding the LR and/or NR may vary based on the TTI length for the receive signal and/or transmit signal.

S1 signaling is extended by including terminal radio capability information for paging. In a case that such paging specific capability information is provided by the base station apparatus to a Mobility Management Entity (MME), the MME may use this information in order to indicate that a paging request from the MME relates to the LR terminal to the base station apparatus. The identifier may be referred to as the ID (Identity, Identifier).

The capability information of the terminal apparatus (UE radio access capability, UE EUTRA capability) starts a procedure for the terminal apparatus in a connection mode in a case that the base station apparatus (EUTRAN) needs the capability information of the terminal apparatus. The base station apparatus inquires the capability information of the terminal apparatus. The terminal apparatus transmits the capability information of the terminal apparatus in response to the inquiry. The base station apparatus determines whether or not the capability information is supported, and in a case of being supported, the base station apparatus transmits the configuration information corresponding to the capability information to the terminal apparatus by using higher layer signaling or the like. The terminal apparatus determines that transmission and/or reception based on its function is possible because the configuration information corresponding to the capability information is configured.

The parameters for the configuration of the physical channel and/or physical signal may be configured as higher layer parameters for the terminal apparatus through higher layer signaling. Some of the parameters for physical channel and/or physical signal, may be configured for the terminal apparatus through L1 signaling such as the DCI format or the grant (physical layer signaling, for example, the PDCCH/EPDCCH). The parameters for the configuration of the physical channel and/or physical signal may be configured in advance in the terminal apparatus with a default configuration or default values. In a case that the terminal apparatus is notified of the parameters for the configuration by using higher layer signaling, the terminal apparatus may update the default values. Types of higher layer signaling/message used to notify of the configuration may be different depending on the corresponding configuration. For example, the higher layer signaling/message may include an RRC message, broadcast information, system information, and the like.

In a case that the base station apparatus transmits the DS at a LAA frequency, the base station apparatus may map the data information and/or control information in a DS occasion. The data information and/or control information may include information of the LAA cell. For example, the data information and/or control information may include a frequency to which the LAA cell belongs, a cell ID, a load or a congestion condition, interference/transmit power, a channel occupation time, or a buffer state relating to transmission data.

In a case that the DS is measured at the LAA frequency, a resource used for each signal included in the DS may be extended. For example, for the CRS, resources corresponding to not only antenna port 0 but also antenna port 2 or 3 may be used. For the CSI-RS also, resources corresponding to not only antenna port 15 but also antenna port 16 or 17 may be used.

In the LR cell, in a case that a resource for the DS is configured for the terminal apparatus through higher layer signaling (RRC signaling) or the system information, whether to receive the DS may be dynamically indicated to the terminal apparatus through L1 signaling (control information corresponding to the PDCCH or a certain field of the DCI format) or L2 signaling (the control information corresponding to the MAC CE), that is, lower layer signaling (signaling by lower layers than an RRC layer).

In the LR cell, the RS for demodulation/decode and the RS for CSI measurement may be a common resource, or different resources in a case of being individually defined.

Next, cell search in the present embodiment will be described.

In the LTE, the cell search is a procedure in which the terminal apparatus performs time-frequency synchronization for a certain cell, and detects a cell ID of the cell. EUTRA cell search supports 72 subcarriers or more and supports all transmission bandwidths scalable. The EUTRA cell search is performed in the downlink based on the PSS and SSS. The PSS and SSS are transmitted using 72 subcarriers at the center of the bandwidth of the first subframe and the sixth subframe of each radio frame. Adjacent cell search is performed as an initial cell search based on the same downlink signal.

In the LR, in a case that a standalone type communication is performed, the cell search similar to the above may be performed.

Next, a description is given of physical layer measurement according to the present embodiment.

In LTE, examples of the physical layer measurement include intra-frequency and inter-frequency intra-EUTRAN measurements (RSRP/RSRQ), measurements related to a time difference in reception and/or transmission of the terminal apparatus or a reference signal time difference used for positioning of the terminal apparatus (RSTD), inter-RAT related measurement (EUTRAN-GERAN/UTRAN), and inter-system related measurement (EUTRAN-non 3GPP RAT). The physical layer measurement is performed to support mobility. The EUTRAN measurement includes measurement performed by the terminal apparatus in an idle mode and a measurement performed by the terminal apparatus in a connection mode. The terminal apparatus performs the EUTRAN measurement in a proper measurement gap to synchronize with the cell subjected to the EUTRAN measurement. These measurements are performed by the terminal apparatus, and therefore, may be referred to as the measurement of the terminal apparatus.

For the terminal apparatus, at least two physical amounts (RSRP, RSRQ) may be supported in the inter-EUTRAN measurement. For the terminal apparatus, a physical amount for the RSSI may be supported. The terminal apparatus may perform the corresponding measurement based on parameters for the physical amounts configured as higher layer parameters.

The physical layer measurement is performed to support mobility. For example, examples of the physical layer measurement include intra-frequency and inter-frequency intra-EUTRAN measurements (RSRP/RSRQ), measurements related to a time difference in reception and/or transmission of the terminal apparatus or a reference signal time difference used for positioning of the terminal apparatus (RSTD), inter-RAT related measurement (EUTRAN-GERAN/UTRAN), and inter-system related measurement (EUTRAN-non 3GPP RAT). For example, the physical layer measurement includes intra- and inter-frequency handover related measurements, inter-RAT handover related measurement, timing measurement, RRM related measurements, and positioning related measurements in a case that positioning is supported. The inter-RAT handover related measurement is defined in the support of the handover to GSM (registered trademark), UTRA FDD, UTRA TDD, CDMA2000, 1xRTT, CDMA2000 HRPD, and IEEE802.11. The EUTRAN measurement is performed to support mobility. The EUTRAN measurement includes measurement performed by the terminal apparatus in an idle mode and a measurement performed by the terminal apparatus in a connection mode. For example, the RSRP or the RSRQ may be measured for each of the intra- and inter-frequencies even if the terminal apparatus is in either of the idle mode and the connection mode. The terminal apparatus performs the EUTRAN measurement in a proper measurement gap to synchronize with the cell subjected to the EUTRAN measurement.

The physical layer measurement includes that the radio performance is measured by the terminal apparatus and the base station apparatus, and reported to the higher layers in the network.

Next, a description is given of an example of a mapping procedure in which a reference signal associated with a certain physical channel is mapped to the physical resource according to the present embodiment.

The terminal apparatus uses at least a first parameter to generate a sequence for a first reference signal. At least the first parameter may be configured based on the terminal apparatus speed. For example, in a case that the terminal apparatus speed does not exceed a first threshold (prescribed threshold), the first parameter may be set to a first value. In a case that the terminal apparatus speed exceeds the first threshold, the first parameter may be set to a second value. The terminal apparatus generates a sequence for a second reference signal in the same subframe and/or in the same TTI, based on the sequence for the first reference signal. Mapping the sequence for the second reference signal to the physical resource may be performed based on the sequence for the first reference signal. For example, in a case that the sequence for the first reference signal is generated using the first value, a first mapping may apply to mapping the sequence for the second reference signal to the physical resource. In a case that the sequence for the first reference signal is generated using the second value, a second mapping may apply to mapping the sequence for the second reference signal to the physical resource. The first mapping is independent from the terminal apparatus speed and is fixed and/or specific and/or particular mapping, and the second mapping is mapping varying based on the terminal apparatus speed and/or the first sequence.

In a case that the terminal apparatus exceeds a second threshold (e.g., the first threshold<the second threshold), the first parameter may be set to a third value.

A range where the first parameter can be selected or switched (which may be values set as choices) may be configured through higher layer signaling or the system information.

In a case that the first reference signal is used to demodulate the sidelink physical channel, the terminal apparatus may determine whether to map the second sequence for the second reference signal to the physical resource in the same subframe and/or in the same TTI based on the first sequence for the first reference signal. For example, in a case that the first sequence is a third sequence, the second sequence may not be mapped to the physical resource in the same subframe and/or in the same TTI. In a case that the first sequence is a fourth sequence, the second sequence may be mapped to the physical resource in the same subframe and/or in the same TTI. The TTI may include the sTTI. Specifically, the TTI may include a TTI different in a length (the number of symbols).

A symbol to which the first sequence is mapped may be different from a symbol to which the second sequence is mapped. A physical resource (resource element, symbol) to which the first sequence is mapped may be different from a physical resource to which the second sequence is mapped. A resource element and/or the number of symbols to which the first sequence is mapped may be different from a resource element and/or the number of symbols to which the second sequence is mapped. The physical resource may be a physical resource in the subframe and/or in the TTI. The physical resource may be a particular resource element in a particular symbol.

The terminal apparatus assumes, with respect to the sidelink transmission (transmission of the sidelink physical channel) from another terminal apparatus, mapping the second sequence for the second reference signal in the same subframe and/or in the same TTI to the physical resource based on the first sequence for the first reference signal included in the sidelink transmission to perform the reception process on the sidelink physical channel. For example, in a case that the first sequence for the received first reference signal is the third sequence, the terminal apparatus assumes that mapping the second sequence for the second reference signal transmitted in the same subframe and/or in the same TTI to the physical resource is the first mapping to perform the reception process on the sidelink physical channel. In a case that the first sequence for the received first reference signal is the fourth sequence, the terminal apparatus assumes that mapping the second sequence for the second reference signal transmitted in the same subframe and/or in the same TTI to the physical resource is the second mapping to perform the reception process on the sidelink physical channel. The reception process may include a demodulation process. The reception process may include a decode process. The reception process may include a process for extracting information (data information (user data) and control information (control data)) from the received signal.

The terminal apparatus may assume, with respect to the sidelink transmission (transmission of the sidelink physical channel) from another terminal apparatus, whether or not the second sequence for the second reference signal in the same subframe and/or in the same TTI is mapped to the physical resource based on the first sequence for the first reference signal included in the sidelink transmission.

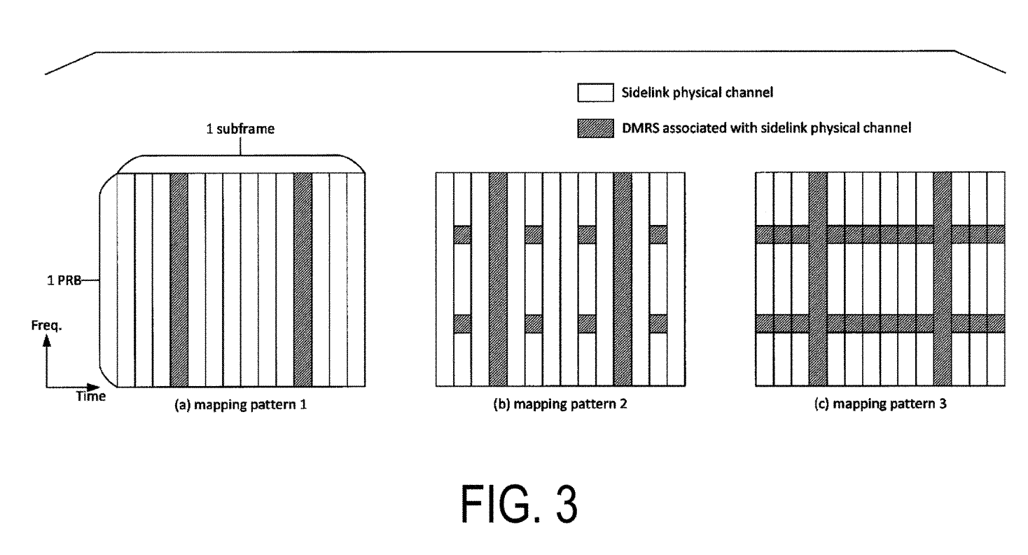

FIGS. 3A to 3C are diagrams illustrating examples of the mapping of a sidelink physical channel and/or a DMRS associated with the sidelink physical channel to the physical resource based on the terminal apparatus speed according to the present embodiment. FIG. 3A illustrates an example of the mapping of a sidelink physical channel and/or a DMRS associated with the sidelink physical channel in a case that the terminal apparatus speed is a first speed (e.g., low speed). FIG. 3B illustrates an example of the mapping of a sidelink physical channel and/or a DMRS associated with the sidelink physical channel in a case that the terminal apparatus speed is a second speed (e.g., middle speed). FIG. 3C illustrates an example of the mapping of a sidelink physical channel and/or a DMRS associated with the sidelink physical channel in a case that the terminal apparatus speed is a third speed (e.g., high speed). The resource in the time direction may increase based on the terminal apparatus speed. In a case a preamble mapped to a head in the subframe and/or in the TTI is used to demodulate the sidelink physical channel, the DMRS illustrated in FIG. 3A may not be mapped. Specifically, the sidelink physical channel may be mapped to a symbol to which the DMRS illustrate in FIG. 3A is mapped. The first mapping described above may be the mapping in FIG. 3A. The second mapping described above may be the mapping in FIG. 3B. Each of the first mapping and the second mapping may be a mapping other than the mappings in FIGS. 3A to 3C.

The first reference signal may be at least one or all of elements A1 to A19 below.

Element A1: PSSS

Element A2: SSSS

Element A3: PSBCH and/or DMRS associated with sPSBCH

Element A4: PSDCH and/or DMRS associated with sPSDCH

Element A5: DMRS associated with PSSCH mapped to a particular subframe and/or particular symbol

Element A6: DMRS associated with PSSCH mapped to a particular subframe and/or particular symbol

Element A7: PSS

Element A8: SSS

Element A9: PBCH

Element A10: CRS mapped to a particular subframe and/or particular symbol

Element A11: URS or DMRS mapped to a particular subframe and/or particular symbol

Element A12: CSI-RS mapped to a particular subframe and/or particular symbol

Element A13: PRS mapped to a particular subframe and/or particular symbol

Element A14: PRACH and/or sPRACH

Element A15: PRACH and/or sPRACH and/or preamble signal/sequence (signal having a preamble sequence different from PRACH) mapped to a head (the first symbol) in TTI (sTTI) and/or subframe

Element A16: SRS

Element A17: SRS mapped to a head (the first symbol) in TTI (sTTI) or subframe

Element A18: DMRS associated with PUSCH mapped to a particular subframe and/or particular symbol

Element A19: DMRS associated with PUCCH mapped to a particular subframe and/or particular symbol

A particular subframe may include a particular TTI in the particular subframe.

A particular symbol may include a particular symbol in a particular subframe and/or a particular symbol in a particular TTI.

The first parameter may be at least one or all of elements B1 to B15 below. The following elements may be respectively configured in advance with default values. Some of the elements may be provided through higher layer signaling, or through the DCI format or SCI format.

Element B1: ID configured uniquely to physical channel/physical signal used for sequence generation

Element B2: cyclic shift

Element B3: type of RNTI

Element B4: value of RNTI corresponding to element B3

Element B5: type of attached CP, and a value corresponding to CP

Element B6: subframe number/index

Element B7: slot number/index

Element B8: symbol number/index

Element B9: TTI (sTTI) number/index, or TTI (sTTI) number/index included in a certain subframe

Element B10: antenna port number

Element B11: offset value based on a sequence shift pattern

Element B12: ID configured by DCI

Element B13: ID configured by SCI

Element B14: value calculated/selected based on the terminal apparatus speed

Element B15: ID (zone ID) indicating a zone (coverage) where the terminal apparatus exists (the terminal apparatus is an in-coverage apparatus) or the measurement and/or communication is performed in a case that the whole world or a certain particular area is divided into particular zones

Next, a description is given of an example of sequence generation for the first reference signal and/or second reference signal.

The sequences for the first reference signal and/or second reference signal may be defined based on the cyclic shift and the reference sequence. Lengths of the sequence and reference sequence may be based on the number of subcarriers constituting a bandwidth to which the physical channel and/or physical signal is mapped (that is, the number of resource elements in the frequency direction).

Specifically, the sequence may be defined based on the element B2 described above.

The sequence and the reference sequence may be generated in association with a group number (sequence group number) and a reference sequence number (a reference sequence number in a group). The number of reference sequences in the group may be one or two for each sequence length depending on the case. Definition of the reference sequence may be based on the sequence length. For example, the definition may be different depending on the cases that the sequence length of the reference sequence is longer than 36 (36 may be included) and shorter than 36. In a case that the sequence length of the reference sequence is longer than 36, the reference sequence may be provided based on a Zadoff-Chu (ZC) sequence. In a case that the sequence length of the reference sequence is shorter than 36, a predefined sequence may be used. This predefined sequence may be referred to as a Computer Generated Sequence (CGS). For example, in a case that the sequence lengths used for the first reference signal and second reference signal are different from each other, the first reference signal may be a CGS and the second reference signal may be a ZC sequence.

A group number of a certain slot (a certain TTI) may be defined based on a group hopping pattern (sequence group hopping pattern) and a sequence shift pattern. For example, the group hopping pattern may include 17 kinds of patterns, and the sequence shift pattern may include 30 kinds of patterns. The group hopping pattern is a pattern defined for a certain slot (a certain TTI) for each cell (that is, to be common to the terminal apparatuses in the cell). The sequence shift pattern is a pattern defined for each cell independently from whether or not the group hopping is valid and independently from the slot (TTI). The group hopping pattern and the sequence shift pattern may be used to reduce an inter-cell interference.

The group hopping pattern may be different for each physical channel and/or physical signal.

The group hopping pattern may be defined based on the slot number (TTI number), whether to validate the group hopping, and/or a pseudo-random sequence. The pseudo-random sequence generator may be initialized at the beginning of each radio frame based on a prescribed initial value. The initial value may be the ID configured for the physical channel and/or physical signal, or a physical cell ID.

The group hopping pattern and/or sequence hopping pattern may be used also to reduce an inter-cell interference between the slots.

The hopping pattern or the sequence shift pattern is common to the terminal apparatuses in the cell, but a value of a sequence for a certain resource element may be defined for each terminal apparatus.

In the present embodiment, the pseudo-random sequence may be defined based on a gold sequence and/or an M sequence.

Specifically, the group hopping pattern may be provided based on some or all of the elements B1, B6 to B9, and B15 described above.

The sequence shift pattern may be defined for each physical channel and/or physical signal. For example, a sequence shift pattern for a certain physical channel may be provided based on a physical cell and higher layer parameters for the sequence shift pattern. A sequence shift pattern for physical channel may be provided based on the ID configured for the physical channel.

Specifically, the sequence shift pattern may be provided based on some or all of the elements B1, B11, and B15 describe above.

The sequence hopping may apply to a prescribed sequence length of a physical channel and/or physical signal. A reference sequence number in the reference sequence group may be 0 for a physical channel and/or physical signal shorter than the prescribed sequence length. In a case that a physical channel and/or physical signal is longer than the prescribed sequence length, a reference sequence number in the reference sequence group at a certain slot (a certain TTI) may be defined based on a pseudo-random sequence for a slot number (TTI number). The sequence hopping pattern is defined in a case that the group hopping is invalid and the sequence hopping is valid, and in other cases, the sequence hopping may not be performed. Specifically, the sequence hopping may be used instead of the group hopping in order to hop the sequence between the slots (or between the TTIs). The pseudo-random sequence generator for the pseudo-random sequence for the sequence hopping may be initialized at the beginning of the radio frame based on a prescribed initial value. A prescribed initial value may be provided based on the ID configured for the physical channel and/or physical signal, and/or an offset value for the sequence shift.

Specifically, the sequence hopping pattern may be provided based on some or all of the elements B1, B11, and B15 described above.

The group hopping pattern, the sequence shift pattern, and/or the sequence hopping pattern may be further provided based on the element B14 in a case that the capability of changing the mapping pattern for the physical channel and/or physical signal based on the terminal apparatus speed is supported in the terminal apparatus.

The initialization of the pseudo-random sequence generator may be performed not only at the beginning of the radio frame but also at the beginning of the subframe, at the beginning of the slot, at the beginning of the symbol, or at the beginning of the TTI.

The initial value used to initialize the pseudo-random sequence generator may be provided based on some or all of the elements B1, B3 to B9, B12, and B13 described above. In the case that the capability of changing the mapping pattern for the physical channel and/or physical signal based on the terminal apparatus speed is supported in the terminal apparatus, the initial value may be provided based on the elements B14 and B15 described above in addition to some or all of the elements B1, B3 to B9, B12, and B13.

The sequences for the first reference signal and/or second reference signal may be provided to the antenna port. Specifically, each sequence may be provided based on the parameter corresponding to the element B10 described above.

The cyclic shift for each antenna port may be provided based on the value configured through higher layer signaling and the antenna port number. The value relating to the cyclic shift may be used to configure a phase rotation amount for at least one of the sequence, and/or the resource element to which the sequence is mapped, and/or the resource element to which the sequence corresponding to the antenna port is mapped. Specifically, the phase rotation amount based on the cyclic shift may be individually configured for each sequence, for each resource element, for each antenna port, for each physical channel and/or physical signal, and for each terminal apparatus.

The antenna port (antenna port number) used to transmit the first reference signal and/or the resource element corresponding to the antenna port may vary based on the terminal apparatus speed. Specifically, the terminal apparatus may use the corresponding antenna port to transmit the physical channel and/or physical signal based on the terminal apparatus speed. For example, in a case that the terminal apparatus speed does not exceed the first threshold, the terminal apparatus may use the first antenna port to transmit the first reference signal. In a case that the terminal apparatus speed exceeds the first threshold, the terminal apparatus may use the second antenna port to transmit the first reference signal. Here, the mapping pattern for the first antenna port may be different from the mapping pattern for the second antenna port. The cyclic shift for the first antenna port may be different from the cyclic shift for the second antenna port.

The antenna port (antenna port number) used to transmit the first reference signal and/or the resource element corresponding to the antenna port may be added based on the terminal apparatus speed. For example, in a case of using the first antenna port for the first reference signal for transmission, in a case that the terminal apparatus speed exceeds the first threshold, the terminal apparatus may use the first antenna port and the second antenna port to transmit the first reference signal. The number of added antenna ports (total number) and/or the number of resource elements for the antenna port (total number) may be determined depending on the terminal apparatus speed.

The second reference signal may be at least one or all of elements C1 to C8 below.

Element C1: PSSCH and/or DMRS associated with sPSSCH except for physical resource (resource element) for element A5

Element C2: PSCCH and/or DMRS associated with sPSCCH except for physical resource (resource element) for element A6

Element C3: URS and/or DMRS associated with PDCCH/EPDCCH/sPDCCH

Element C4: URS and/or DMRS associated with PDSCH/sPDSCH

Element C5: CRS except for physical resource (resource element) for element A10

Element C6: URS and/or DMRS except for physical resource (resource element) for element A11

Element C7: DMRS associated with PUCCH and/or sPUCCH

Element C8: DMRS associated with PUSCH and/or sPUSCH

The number of prescribed thresholds may be the number of thresholds. Each prescribed threshold may be capable of being added and/or changed and/or deleted through higher layer signaling. The number of values which can be configured to the first parameter may be configured depending on the number of prescribed thresholds.

Next, a description is given of an example of a configuration procedure for the resource pool according to the present embodiment.

The terminal apparatus is configured with one or more resource pool lists including configuration for one or more resource pools. The terminal apparatus selects the corresponding resource pool list among multiple resource pool lists, based on the terminal apparatus speed. For example, in the case that the terminal apparatus speed does not exceed the first threshold (prescribed threshold), the terminal apparatus may select a first resource pool included in a first resource pool list among multiple resource pool lists. In the case that the terminal apparatus speed exceeds the first threshold, the terminal apparatus may select a second resource pool included in a second resource pool list among multiple resource pool lists.

In the case that the terminal apparatus speed exceeds the second threshold (e.g., the first threshold<the second threshold), the terminal apparatus selects a third resource pool included in a third resource pool list among multiple resource pool lists.

The number of source pool lists to be selected may be determined based on the number of corresponding thresholds.

The terminal apparatus may use the selected resource pool to transmit the corresponding sidelink physical channel. Specifically, the resource pool may be configured for each sidelink physical channel.

The reference signal (DMRS) mappings in the different resource pools included in the same resource pool list may be the same mapping.

Multiple resource pool lists corresponding to the terminal apparatus speed may be provided based on a preconfiguration for the terminal apparatus in the case that the terminal apparatus is an out-of-coverage apparatus, and may be provided based on the SIB associated with the received sidelink or higher layer signaling from the base station apparatus in the case that the terminal apparatus is an in-coverage apparatus.

The terminal apparatus may select a resource pool corresponding to the terminal apparatus speed from one resource pool list, based on the terminal apparatus speed. For example, in the case that the terminal apparatus speed does not exceed the first threshold (prescribed threshold), the terminal apparatus may select the first resource pool from a particular resource pool list. In the case that the terminal apparatus speed exceeds the first threshold, the terminal apparatus may select the second resource pool from a particular resource pool list.

In the case that the terminal apparatus speed exceeds the second threshold (e.g., the first threshold<the second threshold), the terminal apparatus may select the third resource pool from a particular resource pool list.

Mapping of the reference signal from the first resource pool to the n-th resource pool (n is a prescribed value) may be determined based on at least the first parameter and/or second parameter described above included in the configuration for the resource pools.

The resource pool and/or resource pool list may be included for at least one or all of elements D1 to D3 below.

Element D1: configuration for the sidelink communication (in the pedestrian terminal apparatus)

Element D2: configuration for the sidelink discovery (in the pedestrian terminal apparatus)

Element D3: configuration for V2X communication except for the pedestrian terminal apparatus (that is, configuration for the sidelink communication and/or sidelink discovery in the vehicular terminal apparatus)

The mapping of the sidelink physical channel transmitted in the resource pool and/or the associated DMRS to the physical resource may be determined based on at least one or all of elements E1 to E4 below.

Element E1: type of configuration including the resource pool and/or resource pool list (release, version)

Element E2: type of resource pool list including the configuration for the resource pool (release, version)

Element E3: type of configuration for the resource pool (release, version)

Element E4: parameter indicating the mapping pattern included in the configuration for the resource pool

The second parameter may be at least one or all of elements F1 to F6 below.

Element F1: the number of symbols in one subframe and/or in TTI used for mapping of the sidelink physical channel to the physical resource

Element F2: the number of symbols in one subframe and/or in TTI used for mapping of the DMRS associated with the sidelink physical channel to the physical resource

Element F3: the number of resource elements in one symbol in one subframe and/or in TTI used for mapping the DMRS associated with the sidelink physical channel to the physical resource, or an arrangement interval for the resource element used for the DMRS (value for comb-shaped frequency arrangement)

Element F4: parameter indicating whether or not the first reference signal described above is included in the resource pool

Element F5: parameter indicating whether or not the second reference signal described above is included based on the first reference signal described above

Element F6: parameter indicating whether or not the second reference signal described above is included in the resource pool

The terminal apparatus receives the sidelink physical channel, based on the configuration for the resource pool for reception of a certain sidelink physical channel. The terminal apparatus may perform the reception process on the received sidelink physical channel and/or associated DMRS based on the mapping pattern corresponding to the configuration for the resource pool. In a case that the configuration for the resource pool includes the configuration for the first reference signal described above, the terminal apparatus may perform the reception process, based on the first sequence for the first reference signal described above.

In a case that the number of symbols and/or the number of resource elements which are used for the sidelink physical channel and/or DMRS associated with the sidelink physical channel vary based on the terminal apparatus speed, a Transport Block Size (TBS) and/or Modulation and Coding Scheme (MCS) may be limited depending on the number of symbols and/or the number of resource elements. In other words, in a case that the TBS and/or MCS are limited, the number of symbols and/or the number of resource elements which are used for the sidelink physical channel and/or DMRS associated with the sidelink physical channel may be limited.

The physical channel and physical signal according to the present embodiment may be respectively a physical channel and a physical signal having the same configuration as the physical channel and/or physical signal.

A communicable range (communication area) at each frequency controlled by the base station apparatus is regarded as a cell. Here, the communication area covered by the base station apparatus may be different in size and shape for each frequency. Moreover, the covered area may be different for each frequency. A radio network, in which cells having different types of base station apparatuses or different cell radii are located in a mixed manner in the area with the same frequency and/or different frequencies to form a single communication system, is referred to as a heterogeneous network.

The terminal apparatus is in a non-connected state with any network, for example, immediately after being turned on (e.g., at the time of startup). Such a non-connected state is referred to as an idle mode (RRC idle). The terminal apparatus in the idle mode needs to connect with any network in order to perform communication. Specifically, the terminal apparatus needs to be in a connection mode (RRC connection). Here, the network may include the base station apparatus, an access point, a network server, a modem, and the like belonging to the network.

The terminal apparatus and the base station apparatus may employ a technique for aggregating the frequencies (component carriers or frequency bands) of multiple different frequency bands through the CA and treating the resultant as a single frequency (frequency band). A component carrier is categorized as an uplink component carrier corresponding to the uplink (uplink cell) and a downlink component carrier corresponding to the downlink (downlink cell). In the embodiments of the present invention, “frequency” and “frequency band” may be used synonymously.

For example, in a case that each of five component carriers having frequency bandwidths of 20 MHz are aggregated through the CA, a terminal apparatus capable of performing the CA performs transmission and/or reception by assuming that the aggregated carriers have a frequency bandwidth of 100 MHz. Note that component carriers to be aggregated may have contiguous frequencies or frequencies some or all of which are discontiguous. For example, assuming that available frequency bands include an 800 MHz band, a 2 GHz hand, and a 3.5 GHz band, a component carrier may be transmitted in the 800 MHz band, another component carrier may be transmitted in the 2 GHz hand, and yet another component carrier may be transmitted in the 3.5 GHz band. The terminal apparatus and/or the base station apparatus may use the component carriers belonging to the operating hands thereof (component carriers corresponding to the cell) to simultaneously perform transmission and/or reception.

It is also possible to aggregate multiple contiguous or discontiguous component carriers of the same frequency bands. The frequency bandwidth of each component carrier may be a narrower frequency bandwidth (e.g., 5 MHz or 10 MHz) than the receivable frequency bandwidth (e.g., 20 MHz) of the terminal apparatus, and the frequency bandwidths to be aggregated may be different from each other. The terminal apparatus and/or base station apparatus having a function of the NR may support both a cell having backward compatibility with the LTE cell and a cell not having the backward compatibility.

The terminal apparatus and/or base station apparatus having a function of the LR may aggregate multiple component carriers (carrier types, cells) not having the backward compatibility with the LTE cell. Note that the number of uplink component carriers to be allocated to (configured for or added for) the terminal apparatus by the base station apparatus may be the same as or may be fewer than the number of downlink component carriers.

A cell constituted of an uplink component carrier in which an uplink control channel is configured for a radio resource request and a downlink component carrier having a cell-specific connection with the uplink component carrier is referred to as “PCell”. A cell constituted of component carriers other than those of the PCell is referred to as “SCell”. The terminal apparatus receives a paging message, detects update of broadcast information, carries out an initial access procedure, configures security information, and the like in the PCell, and need not perform these operations in the SCells.

Although a PCell is not a target of Activation and Deactivation controls (in other words, considered as being activated at any time), a SCell has activated and deactivated states, the change of which is explicitly specified by the base station apparatus or is made based on a timer configured for the terminal apparatus for each component carrier. The PCell and SCell are collectively referred to as “serving cell”.

In a case that the terminal apparatus and/or base station apparatus supporting both the LTE cell and the LR cell use both the LTE cell and the LR cell to perform communication, the terminal apparatus and/or base station apparatus may configure a cell group for the LTE cell and a cell group for the LR cell. Specifically, each of the cell groups for the LTE cell and the cell group for the LR cell may include a cell corresponding to the PCell.

In a case that the terminal apparatus and/or base station apparatus supporting both the LTE cell and the NR cell use both the LTE cell and the NR cell to perform communication, the terminal apparatus and/or base station apparatus may configure a cell group for the LTE cell and a cell group for the NR cell. Specifically, each of the cell group for the LTE cell and the cell group for the NR cell may include a cell corresponding to the PCell.

The CA achieves communication using multiple component carriers (frequency hands) using multiple cells, and is also referred to as cell aggregation. The terminal apparatus may have radio connection (RRC connection) with the base station apparatus via a relay station device (or repeater) for each frequency. In other words, the base station apparatus of the present embodiment may be replaced with a relay station device.

The base station apparatus manages a cell, which corresponds to an area where terminal apparatuses can communicate with the base station apparatus, for each frequency. A single base station apparatus may manage multiple cells. Cells are classified into multiple types of cells depending on the size of the area (cell size) that allows for communication with terminal apparatuses. For example, the cells are classified into macro cells and small cells. Moreover, the small cells are classified into femto cells, pico cells, and nano cells depending on the size of the area. In a case that a terminal apparatus can communicate with a certain base station apparatus, the cell configured so as to be used for the communication with the terminal apparatus is referred to as “serving cell” while the other cells not used for the communication are referred to as “neighboring cell”, among the cells of the base station apparatus.

In other words, in the CA, multiple serving cells thus configured include one PCell and one or multiple SCells.

The PCell is a serving cell in which an initial connection establishment procedure (RRC Connection establishment procedure) has been performed, a serving cell in which a connection re-establishment procedure (RRC Connection reestablishment procedure) has been started, or a cell indicated as a PCell in a handover procedure. The PCell operates at a primary frequency. At the point of time when a connection is (re)established, or later, a SCell(s) may be configured. Each SCell operates at a secondary frequency. The connection may be referred to as an RRC connection. For the terminal apparatus supporting the CA, a single PCell and one or more SCells may be aggregated.

In a case that more than one serving cells are configured or a secondary cell group is configured, the terminal apparatus holds a received soft channel bit corresponding to at least a prescribed range depending on decoding failure of a code block of the transport block for at least a prescribed number of transport blocks for each serving cell.

A LAA terminal may support functions corresponding to two or more radio access technologies (RAT).

The LAA terminal supports two or more operating bands. Specifically, the LAA terminal supports a function related to the CA.

The LAA terminal may support Time Division Duplex (TDD) or Half Duplex Frequency Division Duplex (HD-FDD). The LAA terminal may support Full Duplex FDD (FD-FDD). The LAA terminal may indicate which duplex mode/frame structure type is supported through higher layer signaling of the capability information or the like.

The LAA terminal may be an LTE terminal of category X1 (X1 is a prescribed value). Specifically, the maximum number of bits of the transport block which can be transmitted/received in one TTI may be extended for the LAA terminal.

A LR terminal may be an LTE terminal of category X2 (X2 is a prescribed value). Specifically, the maximum number of bits of the transport block which can be transmitted/received in one TTI may be extended or reduced for the LR terminal.

A NR terminal may be an LTE terminal of category X3 (X3 is a prescribed value). Specifically, the maximum number of bits of the transport block which can be transmitted/received in one TTI may be extended or reduced for the NR terminal.

In the embodiments of the present invention, the TTI and the subframe may be individually defined.

The LAA terminal may support multiple duplex modes/frame structure types.

Frame structure type 1 can be applied to both the FD-FDD and the HD-FDD. In the FDD, 10 subframes can be used for each of the downlink transmission and the uplink transmission respectively at an interval of 10 ms. The uplink transmission and the downlink transmission are divided in the frequency domain. The terminal apparatus cannot simultaneously perform transmission and reception in the HD-FDD operation, but such a limitation is not put on the FD-FDD operation.

A re-tuning time (a time required for tuning (the number of subframes or the number of symbols)) in a case that the frequency hopping or the frequency for use is changed may be configured through higher layer signaling.

For example, in the LAA terminal, the number of supported downlink transmission modes (PDSCH transmission modes) may be decreased. Specifically, in a case that the number of downlink transmission modes or the downlink transmission mode supported by the LAA terminal are indicated as the capability information from the LAA terminal, the base station apparatus configures a downlink transmission mode based on the capability information. In a case that the LAA terminal is configured with a parameter for the downlink transmission mode which the LAA terminal does not support, the LAA terminal may ignore that configuration. Specifically, the LAA terminal may not perform the process on the downlink transmission mode which the LAA terminal does not support. Here, the downlink transmission mode is used to indicate a transmission method of PDSCH transmission corresponding to the PDCCH/EPDCCH based on the configured downlink transmission mode, the type of the RNTI, the DCI format, and the search space. The terminal apparatus can interpret, based on those pieces of information, whether the PDSCH is transmitted through antenna port 0, transmitted in transmission diversity, transmitted through multiple antenna ports, or the like. The terminal apparatus can properly perform the reception process based on those pieces of information. Even if the DCI of the PDSCH resource allocation is detected from the same kind of DCI format, in a case that the downlink transmission mode or the type of the RNTI is different, that PDSCH is not necessarily transmitted using the same transmission scheme.

In a case that the terminal apparatus supports a function related to simultaneous transmission of the PUCCH and PUSCH and in a case that the terminal apparatus supports a function related to PUSCH repetition transmission and/or PUCCH repetition transmission, the PUCCH and the PUSCH may be repeatedly transmitted prescribed times at a timing when the PUSCH transmission occurs or at a timing when the PUCCH transmission occurs. Specifically, the simultaneous transmission of the PUCCH and PUSCH may be performed at the same timing (that is, in the same subframe).

In such a case, the PUCCH may include a CSI report, a HARQ-ACK, and a SR.

All signals can be transmitted and/or received in the PCell, but some signals may not be transmitted and/or received in the SCell. For example, the PUCCH is transmitted only in the PCell. Unless multiple Timing Advance Groups (TAGs) are configured between the cells, the PRACH is transmitted only in the PCell. The PBCH is transmitted only in the PCell. The MIB is transmitted only in the PCell. However, in a case that a function to transmit the PUCCH or the MIB in the SCell is supported for the terminal apparatus, the base station apparatus may indicate to the terminal apparatus that the PUCCH or the MIB is transmitted in the SCell (at the frequency corresponding to the SCell). Specifically, in the case that the terminal apparatus supports that function, the base station apparatus may configure, for the terminal apparatus, parameters for transmitting the PUCCH or the MIB in the SCell.

In the PCell, Radio Link Failure (RLF) is detected. In the SCell, even if conditions for the detection of RLF are met, the detection of the RLF is not recognized. In a case that the conditions for the RLF are met in the lower layer of the PCell, the lower layer of the PCell notifies the higher layer of the PCell of that the conditions of the RLF are met. Semi-Persistent Scheduling (SPS) or Discontinuous Transmission (DRX) may be performed in the PCell. In the SCell, the DRX the same as in the PCell may be performed. Fundamentally, in the SCell, the MAC configuration information/parameters are shared with the PCell of the same cell group. Some of the parameters (e.g., sTAG-Id) may be configured for each SCell. Some of the timers or counters may be applied only to the PCell. A timer or counter to be applied may be configured only to the SCell.

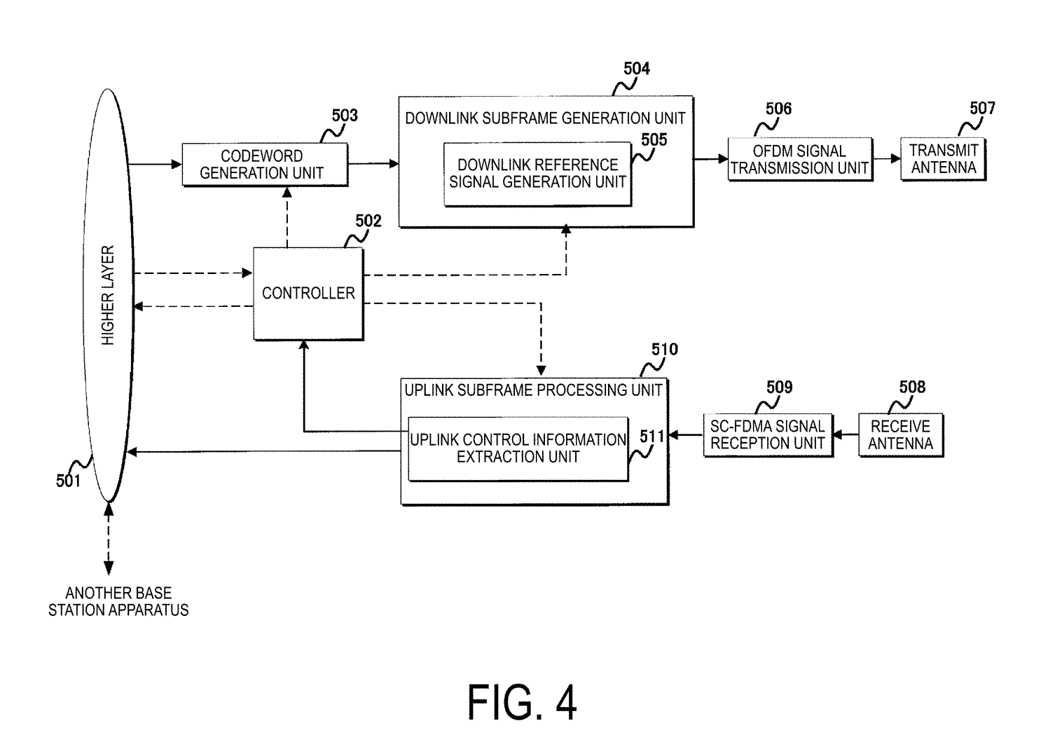

FIG. 4 is a schematic diagram illustrating an example of a block configuration of a base station apparatus 2 according to the present embodiment. The base station apparatus 2 includes a higher layer (higher-layer control information notification unit) 501, a controller (base station control unit) 502, a codeword generation unit 503, a downlink subframe generation unit 504, an OFDM signal transmission unit (downlink transmission unit) 506, a transmit antenna (base station transmit antenna) 507, a receive antenna (base station receive antenna) 508, an SC-FDMA signal reception unit (channel state measurement unit and/or CSI reception unit) 509, and an uplink subframe processing unit 510. The downlink subframe generation unit 504 includes a downlink reference signal generation unit 505. Moreover, the uplink subframe processing unit 510 includes an uplink control information extraction unit (CSI acquisition unit/HARQ-ACK acquisition unit/SR acquisition unit) 511. The SC-FDMA signal reception unit 509 also serves as a measurement unit measuring a received signal, CCA, and interference noise power. In a case that the terminal apparatus supports transmission of the OFDM signal, the SC-FDMA signal reception unit may be an OFDM signal reception unit or may include an OFDM signal reception unit. The downlink subframe generation unit 504 may be a downlink TTI generation unit, or may include a downlink TTI generation unit. The downlink TTI generation unit may be a generation unit generating a physical channel and/or physical signal constituting a downlink TTI. Specifically, the downlink subframe generation unit 504 including the downlink TTI generation unit may include a unit generating a sequence for the physical channel and/or physical signal to be transmitted. The downlink subframe generation unit 504 including the downlink TTI generation unit may include a unit mapping the generated sequence to a physical resource. This can also be applied to the uplink. Although not illustrated in the drawing, the base station apparatus may include a transmitter transmitting a TA command. The base station apparatus may include a receiver receiving a measurement result, reported from the terminal apparatus, related to a time difference between reception and transmission. In a case that the base station apparatus is supported to perform the sidelink, the base station apparatus may include a sidelink transmission unit for generating and transmitting a sidelink subframe and/or sidelink TTI (that is, sidelink signal), and a sidelink reception unit for receiving the sidelink signal and performing demodulation and/or decode.

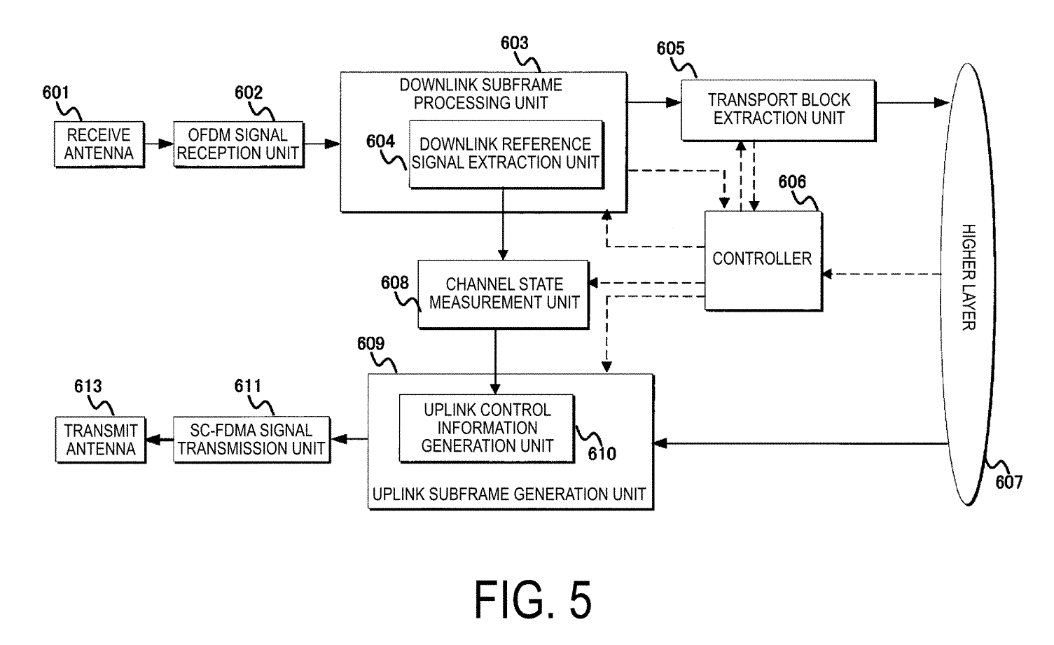

FIG. 5 is a schematic diagram illustrating an example of a block configuration of a terminal apparatus 1 according to the present embodiment. The terminal apparatus 1 includes a receive antenna (terminal receive antenna) 601, an OFDM signal reception unit (downlink reception unit) 602, a downlink subframe processing unit 603, a transport block extraction unit (data extraction unit) 605, a controller (terminal control unit) 606, a higher layer (higher-layer control information acquisition unit) 607, a channel state measurement unit (CSI generation unit) 608, an uplink subframe generation unit 609, SC-FDMA signal transmission units (UCI transmission units) 611 and 612, and transmit antennas (terminal transmit antennas) 613 and 614. The downlink subframe processing unit 603 includes a downlink reference signal extraction unit 604. The downlink subframe processing unit 603 may be a downlink TTI processing unit. Moreover, the uplink subframe generation unit 609 includes an uplink control information generation unit (UCI generation unit) 610. The OFDM signal reception unit 602 also serves as a measurement unit measuring a received signal, CCA, and interference noise power. Specifically, the RRM measurement may be performed in the OFDM signal reception unit 602. In the case that the terminal apparatus supports transmission of the OFDM signal, the SC-FDMA signal transmission unit may be an OFDM signal transmission unit or may include an OFDM signal transmission unit. The uplink subframe generation unit 609 may be an uplink TTI generation unit, or may include an uplink TTI generation unit. The uplink TTI generation unit may be a generation unit generating a physical channel and/or physical signal constituting an uplink TTI. Specifically, the uplink subframe generation unit 609 including the uplink TTI generation unit may include a unit generating a sequence for the physical channel and/or physical signal to be transmitted. The uplink subframe generation unit 609 including the uplink TTI generation unit may include a unit mapping the generated sequence to a physical resource. The terminal apparatus includes a power control unit for configuring/setting a transmit power for an uplink signal. Although not illustrated in the drawing, the terminal apparatus may include a measurement unit for measuring a time difference between reception and transmission of the terminal apparatus. The terminal apparatus may include a transmitter reporting a measurement result related to the time difference.

In a case that the terminal apparatus supports capabilities regarding the sidelink communication and/or sidelink discovery, the downlink subframe processing unit 603 may include a sidelink subframe processing unit and/or sidelink TTI processing unit. The downlink subframe processing unit 603 may have capabilities of processing a sidelink subframe and/or sidelink TTI. Specifically, the downlink subframe processing unit 603 may have the capability of receiving the sidelink TTI.

In the case that the terminal apparatus supports the capabilities regarding the sidelink communication and/or sidelink discovery, the uplink subframe processing unit 609 may include a sidelink subframe generation unit and/or sidelink TTI generation unit. The uplink subframe processing unit 609 may have capabilities of generating a sidelink subframe and/or sidelink TTI. Here, the capabilities of generating the sidelink subframe and/or sidelink TTI may include a capability of generating a sequence for the sidelink physical channel and/or sidelink physical signal, or a capability of mapping the generated sequence to a physical resource.

In each of FIG. 4 and FIG. 5, the higher layer may include a Medium Access Control (MAC), a Radio Link Control (RLC) layer, a Packet Data Convergence Protocol (PDCP) layer, and a Radio Resource Control (RRC) layer.

The RLC layer performs, to the higher layers, Transparent Mode (TM) data transmission, Unacknowledged Mode (UM) data transmission, and Acknowledged Mode (AM) data transmission including indication indicating that Packet Data Unit (PDU) transmission by the higher layer is succeeded. The RLC layer performs, to the lower layers, data transmission, and notification of an entire size of an RLC PDU transmitted at a transmission occasion and a transmission occasion.

The RLC layer supports a function related to transmission of the higher layer PDU, a function related to error correction through an Automatic Repeat reQuest (ARQ) (only for AM data transmission), a function related to combination/partition/restructure of a RLC Service Data Unit (SDU) (only for UM and AM data transmissions), a function related to repartition of a RLC data PDU (only for AM data transmission), a function related to rearrangement of a RLC data PDU (only for AM data transmission), a function related to duplicate detection (only for UM and AM data transmissions), a function related to discard of a RLC SDU (only for UM and AM data transmissions), a function related to re-establishment of RLC, and a function related to protocol error detection (only for AM data transmission).

First, a flow of downlink data transmission and/or reception will be described with reference to FIG. 4 and FIG. 5. In the base station apparatus 2, the controller 502 holds a Modulation and Coding Scheme (MCS) indicating a modulation scheme, a coding rate, and the like in the downlink, downlink resource allocation indicating RBs to be used for data transmission, and information to be used for HARQ control (a Redundancy Version, an HARQ process number, and a New Data Indicator (NDI)), and controls the codeword generation unit 503 and downlink subframe generation unit 504 based on these elements. The downlink data (also referred to as a downlink transport block, DL-SCH data, DL-SCH transport block) transmitted from the higher layer 501 is processed through error correction coding, rate matching, and the like in the codeword generation unit 503 under the control of the controller 502 and then, a codeword is generated. Two codewords at maximum are transmitted at the same time in a single subframe of a single cell. In the downlink subframe generation unit 504, a downlink subframe is generated in accordance with an instruction from the controller 502. First, a codeword generated in the codeword generation unit 503 is converted into a modulation symbol sequence through a modulation process, such as Phase Shift Keying (PSK) modulation or Quadrature Amplitude Modulation (QAM). Moreover, a modulation symbol sequence is mapped onto REs of some RBs, and a downlink subframe for each antenna port is generated through a precoding process. In this operation, a transmission data sequence transmitted from the higher layer 501 includes higher-layer control information, which is control information on the higher layer (e.g., dedicated (individual) Radio Resource Control (RRC) signaling). Moreover, in the downlink reference signal generation unit 505, a downlink reference signal is generated. The downlink subframe generation unit 504 maps the downlink reference signal to the REs in the downlink subframes in accordance with an instruction from the controller 502. The downlink subframe generated in the downlink subframe generation unit 504 is modulated to an OFDM signal in the OFDM signal transmission unit 506 and then transmitted via the transmit antenna 507. Although a configuration of including one OFDM signal transmission unit 506 and one transmit antenna 507 is provided as an example here, a configuration of including multiple OFDM signal transmission units 506 and transmit antennas 507 may be employed in a case that downlink subframes are transmitted on multiple antenna ports. Moreover, the downlink subframe generation unit 504 may also have the capability of generating physical-layer downlink control channels, such as a PDCCH and an EPDCCH, or control channels/shared channels corresponding to the PDCCH and the EPDCCH to map the channels to the REs in downlink subframes. Multiple base station apparatuses transmit separate downlink subframes.

In the terminal apparatus 1, an OFDM signal is received by the OFDM signal reception unit 602 via the receive antenna 601, and an OFDM demodulation process is performed on the signal.

The downlink subframe processing unit 603 first detects physical-layer downlink control channels, such as a PDCCH and an EPDCCH or control channels corresponding to the PDCCH and the EPDCCH. More specifically, the downlink subframe processing unit 603 decodes the signal by assuming that a PDCCH and an EPDCCH, or control channels/shared channels corresponding to the PDCCH and the EPDCCH have been transmitted in the regions to which the PDCCH and the EPDCCH, or control channels/shared channels corresponding to the PDCCH and the EPDCCH are allocated, and checks Cyclic Redundancy Check (CRC) bits added in advance (blind decoding). Specifically, the downlink subframe processing unit 603 monitors a PDCCH and an EPDCCH, or control channels/shared channels corresponding to the PDCCH and the EPDCCH. In a case that the CRC bits match an ID (a single terminal-specific identifier (UEID) assigned to a single terminal, such as a Cell-Radio Network Temporary Identifier (C-RNTI) or a Semi-Persistent Scheduling-C-RNTI (SPS-C-RNTI), or a Temporary C-RNTI) assigned by the base station apparatus beforehand, the downlink subframe processing unit 603 recognizes that a PDCCH and an EPDCCH, or control channels/shared channels corresponding to the PDCCH and the EPDCCH have been detected and extracts the data channels/shared channels corresponding to the PDCCH and the EPDCCH by using control information included in the detected PDCCH and EPDCCH, or the control channels/shared channels corresponding to the PDCCH and the EPDCCH.

The controller 606 holds an MCS indicating a modulation scheme, a coding rate, and the like in the downlink based on the control information, downlink resource allocation indicating RBs to be used for downlink data transmission, and information to be used for HARQ control, and controls the downlink subframe processing unit 603, the transport block extraction unit 605, and the like based on these elements. More specifically, the controller 606 performs control so as to carry out RE demapping process or demodulation process and the like corresponding to RE mapping process and modulation process in the downlink subframe generation unit 504. The PDSCH extracted from the received downlink subframe is transmitted to the transport block extraction unit 605. The downlink reference signal extraction unit 604 in the downlink subframe processing unit 603 extracts the DLRS from the downlink subframe.

In the transport block extraction unit 605, a rate matching rocess, a rate matching process corresponding to error correction coding, error correction decoding, and the like in the codeword generation unit 503 are carried out, and a transport block is extracted and transmitted to the higher layer 607. The transport block includes the higher-layer control information, and the higher layer 607 notifies the controller 606 of a necessary physical-layer parameter based on the higher-layer control information. Multiple base station apparatuses 2 transmit separate downlink subframes, and the terminal apparatus 1 receives the downlink subframes. Hence, the above-described processes may be carried out for the downlink subframe of each of multiple base station apparatuses 2. In this situation, the terminal apparatus 1 may recognize or may not necessarily recognize that multiple downlink subframes have been transmitted from the multiple base station apparatuses 2. In a case that the terminal apparatus 1 does not recognize the subframes, the terminal apparatus 1 may simply recognize that multiple downlinks subframes have been transmitted in multiple cells. Moreover, the transport block extraction unit 605 determines whether the transport block has been detected correctly and transmits the determination result to the controller 606.

Here, the transport block extraction unit 605 may include a buffer unit (soft buffer unit). Information of an extracted transport block can be temporarily stored in the buffer unit. For example, in a case the transport block extraction unit 605 receives the same transport block (retransmitted transport block), and data for this transport block has been failed to be decoded, the transport block extraction unit 605 tries to combine (synthesize) the data for this transport block temporarily stored in the buffer unit with the newly received data, and decode the combined data. In a case that the data temporarily stored becomes unnecessary, or prescribed conditions are met, the buffer unit flushes the data. Conditions for the data to be flushed are different depending on a type of the transport block corresponding to the data. The buffer unit may be prepared for each kind of data. For example, the buffer unit may be prepared as a message 3 buffer or a HARQ buffer, or may be prepared for each layer such as L1/L2/L3. Flushing the information/data includes flushing a buffer in which the information or data is stored.

Next, a flow of uplink signal transmission and/or reception will be described. In the terminal apparatus 1, a downlink reference signal extracted by the downlink reference signal extraction unit 604 is transmitted to the channel state measurement unit 608 under the instruction from the controller 606, the channel state and/or interference is measured in the channel state measurement unit 608, and further CSI is calculated based on the measured channel state and/or interference. The controller 606 instructs the uplink control information generation unit 610 to generate an HARQ-ACK (DTX (not transmitted yet), ACK (detection succeeded), or NACK (detection failed)) and map the resultant to a downlink subframe based on the determination result of whether the transport block is correctly detected. The terminal apparatus 1 performs these processes on the downlink subframe of each of multiple cells. In the uplink control information generation unit 610, a PUCCH including the calculated CSI and/or HARQ-ACK or a control channel/shared channel corresponding to the PUCCH are generated. In the uplink subfratne generation unit 609, the PUSCH including the uplink data transmitted from the higher layer 607 or a control channel/shared channel corresponding to the PUSCH, and the PUCCH or control channel generated by the uplink control information generation unit 610 are mapped to the RBs in an uplink subframe to generate an uplink subframe.

The SC-FDMA signal is received by the SC-FDMA signal reception unit 509 via the receive antenna 508, and an SC-FDMA demodulation process is performed on the signal. The uplink subframe processing unit 510 extracts the RB to which the PUCCH is mapped in accordance with an instruction from the controller 502, and the uplink control information extraction unit 511 extracts the CSI included in the PUCCH. The extracted CSI is delivered to the controller 502. The CSI is used for the controller 502 to control the downlink transmission parameters (MCS, downlink resource allocation, HARQ, and the like). The SC-FDMA signal reception unit may be an OFDM signal reception unit. The SC-FDMA signal reception unit may include an OFDM signal reception unit.

The base station apparatus assumes maximum output P_{CMAX} configured by the terminal apparatus from a power head room report, and based on the physical uplink channel received from the terminal apparatus, assumes the upper limit value of the power for each physical uplink channel. The base station apparatus determines, based on these assumptions, a value of a transmit power control command to the physical uplink channel, and uses the PDCCH including the downlink control information format to transmit the determined value to the terminal apparatus. With this operation, power adjustment is made for the transmit power for the physical uplink channel/signal (or the uplink physical channel/physical signal) transmitted from the terminal apparatus.

In a case that the base station apparatus transmits, to the terminal apparatus, the PDCCH (EPDCCH)/PDSCH (or LR cell shared channels/control channels corresponding thereto), the base station apparatus performs PDCCH/PDSCH resource allocation so as not to allocate to a resource for a PBCH (or a broadcast channel corresponding to the PBCH).

The PDSCH may be used to transmit a message/information regarding each SIB/RAR/paging/unicast for the terminal apparatus.

The frequency hopping for the PUSCH may be individually configured depending on the type of grant. For example, values of parameters used for the frequency hopping for the PUSCH corresponding to each of a dynamic schedule grant, a semi-persistent grant, and a RAR grant may be individually configured. Those parameters may not be indicated in the uplink grant. Those parameters may be configured through higher layer signaling including the system information.

The various parameters described above may be configured for each physical channel. The various parameters described above may be configured for each terminal apparatus. The various parameters described above may be configured to be common to the terminal apparatuses. Here, the various parameters described above may be configured using the system information. The various parameters described above may be configured through higher layer signaling (RRC signaling, MAC CE). The various parameters described above may be configured using the PDCCH/EPDCCH. The various parameters described above may be configured as broadcast information. The various parameters described above may be configured as unicast information.

Note that in the above-described embodiments, the description is given assuming that a power value required by each PUSCH transmission is calculated based on the parameters configured by the higher layer, an adjustment value determined based on the number of PRBs allocated to the PUSCH transmission by resource assignment, downlink path loss and a coefficient by which the path loss is multiplied, an adjustment value determined based on the parameter indicating the offset of the MCS applied to the UCI, a correction value obtained by a TPC command, and the like. Note that the description is given assuming that a power value required by each PUCCH transmission is calculated based on the parameters configured by a higher layer, downlink path loss, an adjustment value determined based on the UCI transmitted by the PUCCH, an adjustment value determined based on the PUCCH format, an adjustment value determined based on the number of antenna ports used for the transmission by the PUCCH, a value based on a TPC command, and the like. However, the power value is not limited to the above. An upper limit value may be set for the required power value, and the smallest value of the value based on the above-described parameters and the upper limit value (e.g., P_{CMAX, c}, which is the maximum output power value of a serving cell c) may be used as the required power value.

A program running on each of the base station apparatus and the terminal apparatus according to an aspect of the present invention may be a program (a program for causing a computer to operate) that controls a Central Processing Unit (CPU) and the like in such a manner as to realize the functions according to the above-described embodiments of the present invention. The information handled in these apparatuses is temporarily accumulated in a Random Access Memory (RAM) while being processed, and thereafter, the information is stored in various types of Read Only Memory (ROM) such as a Flash ROM and a Hard Disk Drive (HDD), and read by the CPU to be modified or rewritten, as necessary.

Note that the terminal apparatus and/or the base station apparatus according to the above-described embodiments may be partially achieved by a computer. In such a case, a program for realizing such control functions may be recorded on a computer-readable recording medium to cause a computer system to read the program recorded on the recording medium for execution.

Note that it is assumed that the “computer system” refers to a computer system built into the terminal apparatus or the base station apparatus, and the computer system includes an OS and hardware components such as a peripheral apparatus. Furthermore, the “computer-readable recording medium” may include a portable medium such as a flexible disk, a magneto-optical disk, a ROM, a CD-ROM, and the like, and a storage apparatus such as a hard disk built into the computer system.

Moreover, the “computer-readable recording medium” may include a medium that dynamically retains the program for a short period of time, such as a communication line that is used to transmit the program over a network such as the Internet or over a communication line such as a telephone line, and a medium that retains, in that case, the program for a certain period of time, such as a volatile memory within the computer system which functions as a server or a client. Furthermore, the “computer-readable recording medium” may be an external memory. Furthermore, the above-described program may be configured to realize some of the functions described above, and additionally may be configured to realize the functions described above, in combination with a program already recorded in the computer system.

Furthermore, the base station apparatus according to the above-described embodiments may be achieved as an aggregation (an apparatus group) constituted of multiple apparatuses. Each of the apparatuses configuring such an apparatus group may include some or all portions of each function or each functional block of the base station apparatus according to the above-described embodiments. The apparatus group may include each general function or each functional block of the base station apparatus. Furthermore, the terminal apparatus according to the above-described embodiments can also communicate with the base station apparatus as the aggregation.

Furthermore, the base station apparatus according to the above-described embodiments may serve as an Evolved Universal Terrestrial Radio Access Network (EUTRAN). Furthermore, the base station apparatus 2 according to the above-described embodiments may have some or all portions of the functions of a node higher than an eNodeB.

Furthermore, some or all portions of each of the terminal apparatus and the base station apparatus according to the above-described embodiments may be typically achieved as an LSI which is an integrated circuit or may be achieved as a chip set. The functional blocks of each of the terminal apparatus and the base station apparatus may be individually achieved as a chip, or some or all of the functional blocks may be integrated into a chip. The circuit integration technique is not limited to LSI, and the integrated circuits for the functional blocks may be realized as dedicated circuits or a multi-purpose processor. Furthermore, in a case that with advances in semiconductor technology, a circuit integration technology with which an LSI is replaced appears, it is also possible to use an integrated circuit based on the technology.

Furthermore, according to the above-described embodiments, the cellular mobile station device (mobile phone, mobile terminal) is described as one example of a terminal apparatus or a communication device, but the present invention is not limited to this, and can be applied to a fixed-type electronic apparatus installed indoors or outdoors, or a stationary-type electronic apparatus, for example, a terminal apparatus or a communication device, such as an audio-video (AV) apparatus, a kitchen apparatus (refrigerator, microwave oven), a cleaning or washing machine, an air-conditioning apparatus, office equipment, a vending machine, in-vehicle equipment such as a car navigation system, and other household apparatuses.

From the above, an aspect of the present invention provides the following characteristics.

(1) A terminal apparatus according to an aspect of the present invention includes a sequence generation unit that generates a first sequence for a first reference signal based on a first parameter, and generates a second sequence for a second reference signal, and a mapping unit that maps each of the sequences to a physical resource, wherein the sequence generation unit sets the first parameter to a first value in a case that a terminal apparatus speed does not exceed a first threshold, and sets the first parameter to a second value in a case that the terminal apparatus speed exceeds the first threshold, and the mapping unit maps the second sequence to a physical resource based on the sequence for the first reference signal.

(2) The terminal apparatus according to an aspect of the present invention is the above terminal apparatus, wherein the sequence generation unit generates the second sequence, based on the sequence for the first reference signal.

(3) The terminal apparatus according to an aspect of the present invention is the above terminal apparatus, wherein the sequence generation unit determines whether to generate the second sequence based on the sequence for the first reference signal.

(4) A method according to an aspect of the present invention is the above terminal apparatus, wherein the second sequence is not generated in the case that the terminal apparatus speed does not exceed the first threshold, and the second sequence is generated in the case that terminal apparatus speed exceeds the first threshold.

(5) The terminal apparatus according to an aspect of the present invention is the above terminal apparatus, wherein the mapping unit applies a first mapping to the mapping of the second sequence to the physical resource in a case that the first sequence for the first reference signal is a third sequence, and applies a second mapping to the mapping of the second sequence to the physical resource in a case that the first sequence for the first reference signal is a fourth sequence.

(6) The terminal apparatus according to an aspect of the present invention is the above terminal apparatus, wherein the sequence generation unit configures the first parameter to a third value in a case that terminal apparatus speed exceeds a second threshold which is larger than the first threshold, and the mapping unit applies a third mapping to the mapping of the second sequence to the physical resource in a case that the sequence for the first reference signal is a fifth sequence.

(7) The terminal apparatus according to an aspect of the present invention is the above terminal apparatus, wherein the first threshold, the first value, the second value, the first mapping and/or the second mapping are indicated with information (parameters) included in a system information block.

(8) The terminal apparatus according to an aspect of the present invention is the above terminal apparatus, wherein in a case that the system information block does not include any parameters for the first threshold, the first value, the second value, the first mapping and/or the second mapping, values configured in the terminal apparatus or an external memory are used for the first threshold, the first value, the second value, the first mapping and/or the second mapping, and in a case that the system information block includes the parameters for the first threshold, the first value, the second value, the first mapping and/or the second mapping, the parameters provides the first threshold, the first value, the second value, the first mapping and/or the second mapping.

(9) The terminal apparatus according to an aspect of the present invention is the above terminal apparatus, wherein the first reference signal is mapped to a head in a Transmission Time Interval (TTI) in a time domain.

(10) The terminal apparatus according to an aspect of the present invention is the above terminal apparatus, wherein the first reference signal includes a Primary Sidelink Synchronization Signal (PSSS) and Secondary Sidelink Synchronization Signal (SSSS), and the second reference signal includes a Demodulation Reference Signal (DMRS).

(11) The terminal apparatus according to an aspect of the present invention is the above terminal apparatus, wherein the first reference signal is a Demodulation Reference Signal (DMRS) associated with a PSBCH, and the second reference signal is a DMRS associated with a PSCCH and/or a PSSCH.

(12) The terminal apparatus according to an aspect of the present invention is the above terminal apparatus, wherein the first reference signal is a Physical Random Access Channel (PRACH), and the second reference signal is a Demodulation Reference Signal (DMRS).

(13) A method according to an aspect of the present invention includes the steps of: generating a first sequence for a first reference signal, based on a first parameter; generating a second sequence for a second reference signal; mapping each of the sequences to a physical resource; configuring the first parameter to a first value in a case that a terminal apparatus speed does not exceed a first threshold; configuring the first parameter to a second value in a case that the terminal apparatus speed exceeds the first threshold; and mapping the second sequence to a physical resource based on the sequence for the first reference signal.

(14) A terminal apparatus according to an aspect of the present invention includes: a transmitter configured to transmit a first sidelink physical channel and a Demodulation Reference Signal (DMRS) associated with the first sidelink physical channel, based on a first resource pool list and a second resource pool list; and a resource configuration unit configured to select the first resource pool list or the second resource pool list, based on a terminal apparatus speed, wherein the resource configuration unit selects a first resource pool from the first resource pool list in a case that the terminal apparatus speed does not exceed a first threshold, and selects a second resource pool from the second resource pool list in a case that the terminal apparatus speed exceeds the first threshold, and mapping of the first sidelink physical channel and/or mapping of the DMRS in a Transmission Time Interval (TTI) for the first resource pool are different from mapping of the first sidelink physical channel and/or mapping of the DMRS in a TTI for the second resource pool.

(15) The terminal apparatus according to an aspect of the present invention is the above terminal apparatus, wherein in a case that the terminal apparatus is an out-of-coverage apparatus, the first resource pool list and the second resource pool list are provided based on a preconfiguration for the terminal apparatus.

(16) The terminal apparatus according to an aspect of the present invention is the above terminal apparatus, wherein in a case the terminal apparatus is an in-coverage apparatus, the first resource pool list and the second resource pool list are provided based on a received System Information Block (SIB).

(17) The terminal apparatus according to an aspect of the present invention is the above terminal apparatus, wherein the terminal apparatus includes a receiver that receives the first sidelink physical channel and the DMRS, based on a third resource pool list and a fourth resource pool list, wherein the receiver receives the first sidelink physical channel and the DMRS based on the third resource pool list and the fourth resource pool list included in the preconfiguration for the terminal apparatus in the case that the terminal apparatus is the out-of-coverage apparatus, and mapping of the first sidelink physical channel and the associated DMRS in a third resource pool included in the third resource pool list is different from mapping of the first sidelink physical channel and the associated DMRS in a fourth resource pool included in the fourth resource pool

(18) The terminal apparatus according to an aspect of the present invention is the above terminal apparatus, wherein in the case that the terminal apparatus is the in-coverage apparatus, mapping of the first sidelink physical channel and the associated DMRS in the third resource pool, and mapping of the first sidelink physical channel and the associated DMRS in the third resource pool are determined based on parameters included in the received System Information Block (SIB).

(19) A method according to an aspect of the present invention includes the steps of: transmitting a first sidelink physical channel and a Demodulation Reference Signal (DMRS) associated with the first sidelink physical channel, based on a first resource pool list and a second resource pool list; selecting the first resource pool list or the second resource pool list, based on a terminal apparatus speed; selecting a first resource pool from the first resource pool list in a case that the terminal apparatus speed does not exceed a first threshold; and selecting a second resource pool from the second resource pool list in a case that the terminal apparatus speed exceeds the first threshold, wherein mapping of the first sidelink physical channel and/or mapping of the DMRS in a Transmission Time Interval (TTI) for the first resource pool are different from mapping of the first sidelink physical channel and/or mapping of the DMRS in a TTI for the second resource pool.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications can be made to an aspect of the present invention within the scope defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

An aspect of the present invention can be used for, for example, a communication system, communication equipment (e.g., mobile phone device, a base station apparatus, a wireless LAN device, or a sensor device), an integrated circuit (e.g., communication chip), a program, or the like.

### REFERENCE SIGNS LIST

501 Higher layer
502 Controller
503 Codeword generation unit
504 Downlink subframe generation unit
505 Downlink reference signal generation unit
506 OFDM signal transmission unit
507 Transmit antenna
508 Receive antenna 509 SC-FDMA signal reception unit
510 Uplink subframe processing unit
511 Uplink control information extraction unit
601 Receive antenna
602 OFDM signal reception unit
603 Downlink subframe processing unit
604 Downlink reference signal extraction unit
605 Transport block extraction unit
606 Controller
607 Higher layer
608 Channel state measurement unit
609 Uplink subframe generation unit
610 Uplink control information generation unit
611, 612 SC-FDMA signal transmission unit
613, 614 Transmit antenna

1-13. (canceled)

14. A terminal device comprising:
a sequence generator configured to generate a sequence for a reference signal for sidelink, and
a mapper configured to map the sequence to a physical resource,
wherein the sequence generator is configured to set a first parameter to a first value or a second value based on a state of the terminal device,
wherein the mapper is configured to apply first mapping in a case that the first parameter is set to the first value, and
the mapper is configured to apply second mapping in a case that the first parameter is set to the second value.

15. A method of a terminal device comprising:
generating a sequence for a reference signal for sidelink;
mapping the sequence to a physical resource;
wherein
applying first mapping in a case that the first parameter is set to the first value, and
applying second mapping in a case that the first parameter is set to the second value.
